(19) United States
(12) Patent Application Publication
(10) Pub. No.: US 2015/0035644 A1
(43) Pub. Date: Feb. 5, 2015

(54) EVENT MANAGEMENT SYSTEM

(71) Applicant: Wave Technologies, LLC, New Orleans, LA (US)

(72) Inventors: Rana June, New Orleans, LA (US); Harold Cole Wiley, New Orleans, LA (US); Michael Cousins, New Iberia, LA (US)

(73) Assignee: Wave Technologies, LLC, New Orleans, LA (US)

(21) Appl. No.: 13/954,568

(22) Filed: Jul. 30, 2013

(51) Int. Cl. G06K 7/10; G07C 9/00

(52) U.S. Cl. CPC G06K 7/10366; G07C 9/00111
USPC 340/5.61

(57) ABSTRACT

An event management system is provided. The event management system comprises at least one wearable device that includes a wearable support structure, a display coupled to the support structure, a plurality of sensors coupled to the support structure, a controller removably coupled to the display, the plurality of sensors, and the support structure, the controller including one or more processors coupled to a memory and one or more antennas, and a user manager component executable by the one or more processors of the controller and configured to create anonymous biometric information descriptive of at least one user wearing the at least one wearable device based at least in part on information received from the plurality of sensors and transmit at least one portion of the anonymous biometric information.

### BACKGROUND

1. Technical Field

The technical field relates generally to systems and methods of collecting information from and interacting with event attendees.

2. Background Discussion

Venues traditionally employ paper-based systems to manage attendee access to events. These paper-based systems include, for example, printed tickets, wristbands, or passes for venue entry. For example, barcodes may be printed on paper tickets that are distributed to event attendees prior to an event. Upon entry to a venue, the event attendees may present their tickets for scanning by a bar code reader. The scanning system may check the validity of the ticket and thereby prevent counterfeit tickets. Other systems employ Radio Frequency Identification (RFID) tags built into tickets or passes. These tickets or passes can be read by an RFID reader placed at the entrance to a venue. The RFID information in the ticket or pass may be used to access identification information associated with the ticket or pass holder in a fashion similar to United States Passport Cards.

### SUMMARY

Aspects and embodiments disclosed herein present systems and methods of event management that enable various information consumers (e.g., event constituents) to monitor and interact with attendees at an event. For instance, some embodiments disclosed herein employ a wearable device that is worn by each event attendee. In these embodiments, the wearable device monitors a plurality of parameters associated with the user (e.g., heart rate, blood pressure, skin conductance, and location) through a plurality of sensor devices integrated into the wearable device. The collected user information may be transmitted to an external system (e.g., a server system). The aggregated and analyzed user information in the server system is then made available to the various information consumers (e.g., through a user interface).

In addition, various examples of the event management system disclosed herein support transactions between, for example, an information consumer and an event attendee (e.g., a wearable device user). Example transactions between an information consumer and an event attendee include, but are not limited to, financial transactions to purchase items at the venue and registration transactions for access to specified locations or entry into various contests during the event. In addition, the event management system may support transactions between vendors outside the event management system and event attendees (e.g., wearable device users). It is appreciated that the supported transactions may also provide a method to detect and stop fraudulent transactions by verifying the identity of a wearable device user.

According to one aspect, an event management system is provided. The event management system comprises at least one wearable device that includes a wearable support structure, a display coupled to the support structure, a plurality of sensors coupled to the support structure, a controller removably coupled to the display, the plurality of sensors, and the support structure, the controller including one or more processors coupled to a memory and one or more antennas, and a user manager component executable by the one or more processors of the controller and configured to create anonymous biometric information descriptive of at least one user wearing the at least one wearable device based at least in part on information received from the plurality of sensors and transmit at least one portion of the anonymous biometric information.

According to one embodiment, the wearable support structure includes at least one of a wristband, a pair of glasses, a belt buckle, a headband, and a ring. According to one embodiment, the plurality of sensors includes at least one of an accelerometer, a microphone, a temperature sensor, a galvanic skin response sensor, and a heart rate sensor.

According to one embodiment, the user manager is configured to verify transactions between the at least one user and a third party. According to one embodiment, the user manager is configured to verify the transactions between the at least one user and the third party at least in part by receiving a user verification request, requesting the at least one user to perform an action, determining whether the action was performed based at least in part on the information received from the plurality of sensors, and transmitting a user verification outcome. According to one embodiment, the user manager is configured to request an action that moves the at least one wearable device according a predetermined movement.

According to one embodiment, the at least one wearable device includes a plurality of wearable devices, the at least one user includes a plurality of users, and the user manager component is configured to transmit anonymous biometric information to an external system. The external system comprises a memory, one or more processors communicatively coupled with the memory and the plurality of wearable devices, an event manager executable by the one or more processors. The event manager is configured to aggregate anonymous biometric information received from each wearable device of the plurality of wearable devices into aggregated biometric information descriptive of the plurality of users and provide a selected portion of the aggregated biometric information to one or more information consumers.

According to one embodiment, the memory further stores associations between the one or more information consumers and one or more information consumer types, the information consumer types including at least an artist type, an event manager type, and a tour management type and the event manager is configured to provide the selected portion of the aggregated biometric information based upon the associations. According to one embodiment, the event manager is further configured to facilitate a transaction between a user of the plurality of users and the third party. According to one embodiment, memory stores biometric information descriptive of each user of the plurality of users and the event manager is configured to facilitate the transaction at least in part by receiving a transaction request from the third party identifying the user, transmitting, in response to receiving the transaction request, biometric information of the user to an information consumer, receiving a confirmation of matching biometric information from the information consumer, transmitting, in response to receiving the confirmation, a user verification request to a wearable device worn by the user, and receiving a user verification from the wearable device.

According to one embodiment, the memory stores the aggregated biometric information, the aggregated biometric information including at least one of an aggregate heart rate, an aggregate temperature, and an aggregate energy level for the plurality of users. According to one embodiment, the event management system further comprises an interface component executable by the one or more processors. The interface component is configured to retrieve at least one portion of the aggregated biometric information from the memory and present a first representation based on the aggregated biometric information, the first representation including an indication of at least one of a current event attendance, an average crowd heart rate, an average crowd temperature, and an average crowd energy level. According to one embodiment, the interface component is further configured to present a second representation including an indication of at least one of a current set attendance, an event map, and merchandise sold and present a third representation including an indication of at least one of an artist transportation schedule, an artist lodging schedule, and an artist performance schedule.

According to one aspect, an event management system for providing information regarding a plurality of users to one or more information consumers is provided. The event management system comprises a memory storing aggregated biometric information regarding a plurality of users, the aggregated biometric information including at least one of a heart rate, a temperature, and an energy level for the plurality of users, one or more processors coupled to the memory, and an interface component executable by the one or more processors. The interface component is configured to retrieve at least one portion of the aggregated biometric information from the memory, and present a first representation based on the aggregated biometric information, the first representation including an indication of at least one of a current event attendance, an average crowd heart rate, an average crowd temperature, and an average crowd energy level.

According to one embodiment, the interface component is further configured to present a second representation including an indication of at least one of a current set attendance, an event map, and an indication of merchandise sold and present a third representation including an indication of at least one of an artist transportation schedule, an artist lodging schedule, and an artist performance schedule. According to one embodiment, the memory further stores associations between the one or more information consumers and one or more information consumer types, the information consumer types including at least an artist type, an event manager type, and a tour management type and the interface is configured to retrieve the at least one portion of the aggregated biometric information based upon the associations.

According to one aspect, a method of managing an event is provided. The method comprises receiving, by at least one wearable device, biometric information descriptive of at least one user, and transmitting, by the at least one wearable device, anonymous biometric information using the biometric information.

According to one embodiment, the method further comprises receiving the anonymous biometric information and aggregating the anonymous biometric information into aggregated biometric information. According to one embodiment, the method further comprises providing the aggregated biometric information to an information consumer. According to one embodiment, providing the aggregated biometric information includes providing the aggregated biometric information to an artist performing at the event.

Still other aspects, embodiments, and advantages of these exemplary aspects and embodiments, are discussed in detail below. Moreover, it is to be understood that both the foregoing information and the following detailed description are merely illustrative examples of various aspects, and are intended to provide an overview or framework for understanding the nature and character of the claimed subject matter. Any embodiment disclosed herein may be combined with any other embodiment. References to “an embodiment,” “an example,” “some embodiments,” “some examples,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. The appearances of such terms herein are not necessarily all referring to the same embodiment.

Furthermore, in the event of inconsistent usages of terms between this document and documents incorporated herein by reference, the term usage in the incorporated references is supplementary to that of this document; for irreconcilable inconsistencies, the term usage in this document controls. In addition, the accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a functional schematic of one example of an event management system;

FIG. 2 is a functional schematic of one example of a wearable device controller that may perform processes and functions disclosed herein;

FIGS. 3A-E are illustrations of an example wearable device;

FIG. 4 is another illustration of an example wearable device;

FIG. 5 is a flow diagram illustrating a wearable device process;

FIG. 6 is a flow diagram illustrating a wearable device connection process;

FIG. 7 is a flow diagram illustrating a wearable device access verification process;

FIG. 8 is a flow diagram illustrating a wearable device transaction verification process;

FIG. 9 is a diagram showing a process for interacting with an event management system;

FIG. 10 is a block diagram of a general-purpose computer system upon which various embodiments or examples may be implemented;

FIG. 11 is an illustration of a user interface for an event management system;

FIGS. 12A-D are other illustrations of a user interface for an event management system;

FIG. 13 is another illustration of a user interface for an event management system;

FIGS. 14A-D are other illustrations of a user interface for an event management system;

FIG. 15 is another illustration of a user interface for an event management system;

FIG. 16 is another illustration of a user interface for an event management system;

FIGS. 17A-C are other illustrations of a user interface for an event management system;

FIG. 18 is a flow diagram illustrating an event management system wearable device connection;

FIG. 19 is a flow diagram illustrating an event management system process for wearable device access verification;

FIG. 20 is a flow diagram illustrating another event management system process for wearable device access verification;

FIG. 21 is a flow diagram illustrating an event management system process for processing an information request; and

FIG. 22 is a flow diagram illustrating another event management system process for processing an information request.

### DETAILED DESCRIPTION

Some aspects and embodiments disclosed herein relate to apparatuses and processes of managing attendees during an event. For instance, processes and apparatuses in accord with some embodiments collect user information through the use of wearable devices worn by event attendees. In these embodiments, the wearable devices collect relevant user information and transmit the information to a wearable device reader in communication with a server system. The server system aggregates the user information from the plurality of users. The aggregated information is then presented to the various information consumers through one or more user interfaces. It is appreciated that these user interfaces may only present relevant portions of aggregated user information based upon the type of information consumer.

Additionally, in some embodiments, the event management system disclosed herein enables interaction between the various information consumers and the wearable devices. For example, the event management system may support transactions between an information consumer and an event attendee (e.g., a wearable device user). Example transactions between an information consumer and an event attendee include, but are not limited to, financial transactions to purchase items at the venue or registration transactions for various contests or access to specified locations during the event. It is appreciated that the event management system may support transactions between vendors outside the event management system and event attendees (e.g., wearable device users).

The examples of the methods and apparatuses discussed herein are not limited in application to the details of construction and the arrangement of components set forth in the following description or illustrated in the accompanying drawings. The methods and apparatuses are capable of implementation in other examples and of being practiced or of being carried out in various ways. Examples of specific implementations are provided herein for illustrative purposes only and are not intended to be limiting. In particular, acts, elements and features discussed in connection with any one or more examples or embodiments are not intended to be excluded from a similar role in any other examples or embodiments.

Also, the phraseology and terminology used herein is for the purpose of description and should not be regarded as limiting. Any references to embodiments, examples, or elements or acts of the systems and methods herein referred to in the singular may also embrace examples or embodiments including a plurality of these elements, and any references in plural to any embodiment, example, or element or act herein may also embrace embodiments and examples including only a single element. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

### Event Management System

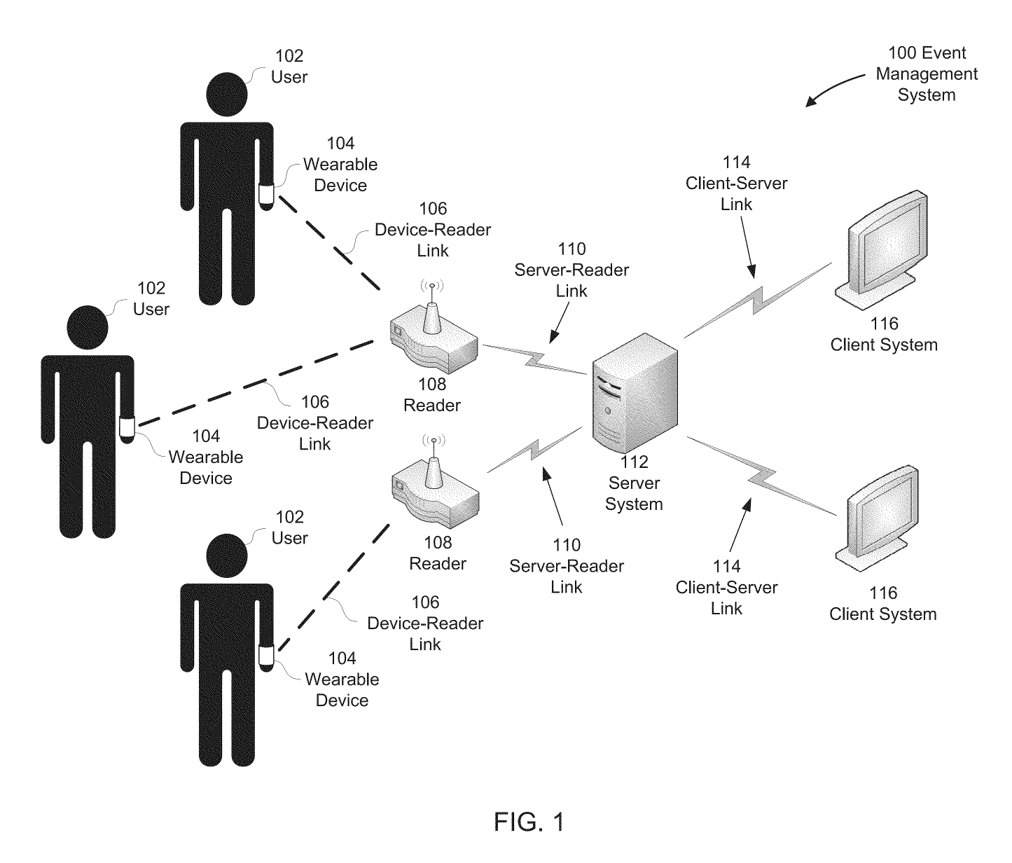

Various examples disclosed herein implement an event management system. FIG. 1 illustrates one example event management system 100. As shown, the event management system 100 includes a wearable device 104 worn by a user 102, a wearable device reader 108 connected to various wearable devices via a device-reader link 106, a server system 112 in communication with the readers 108 via a server-reader link 110, and a client system 116 in communication with the server system 112 via a client-server link 114.

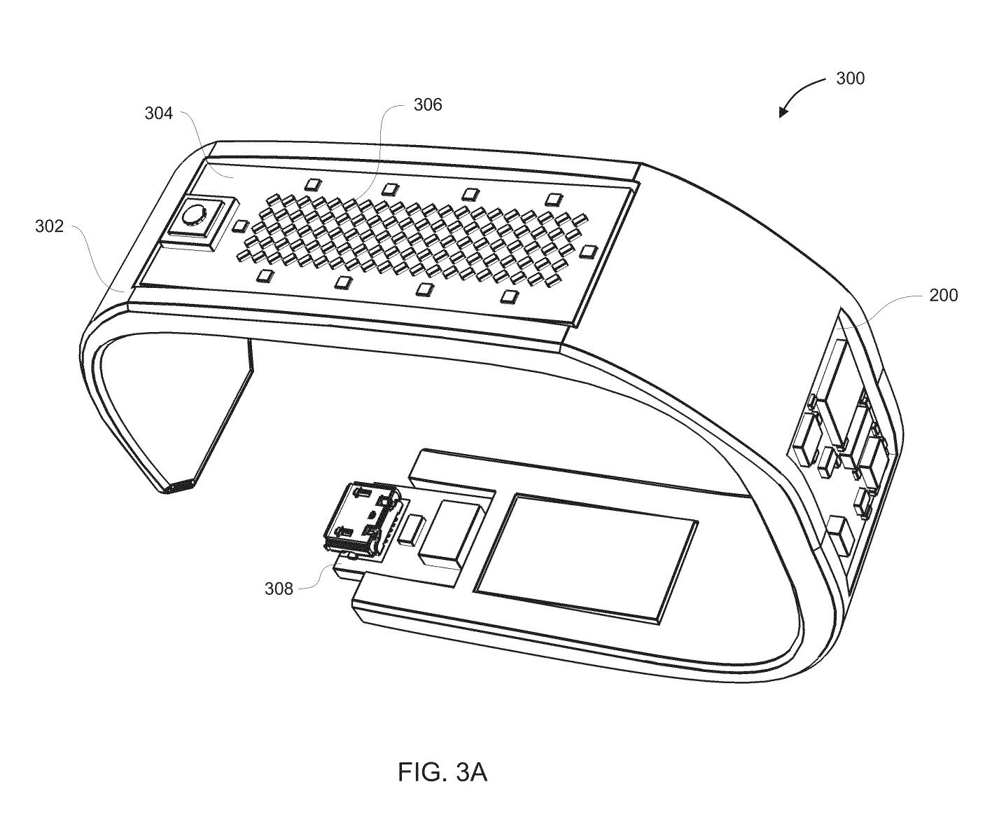

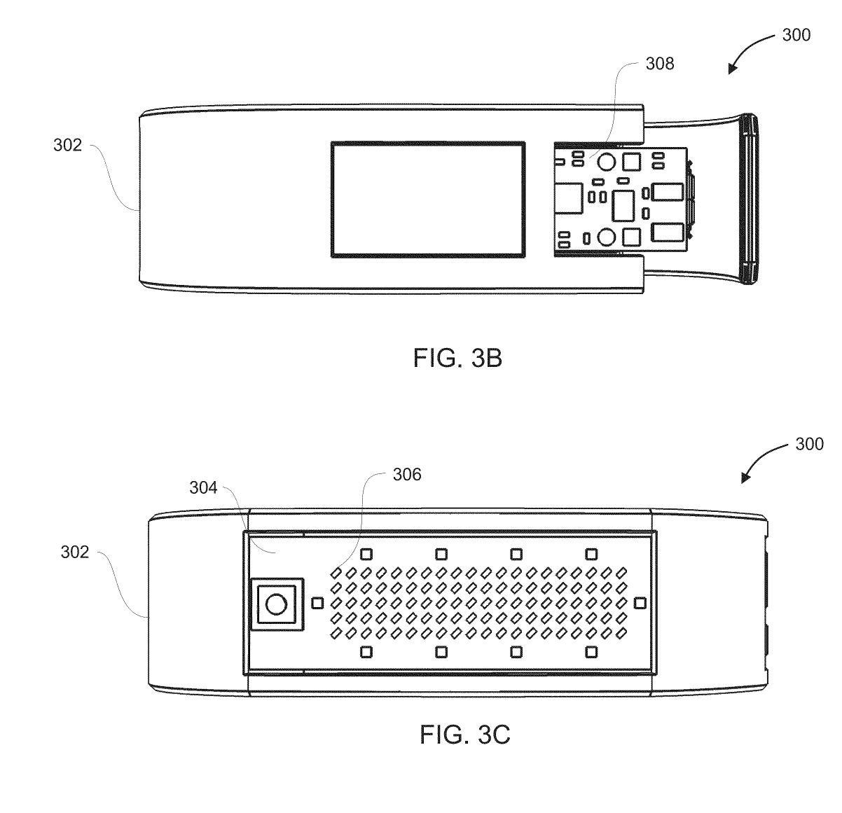

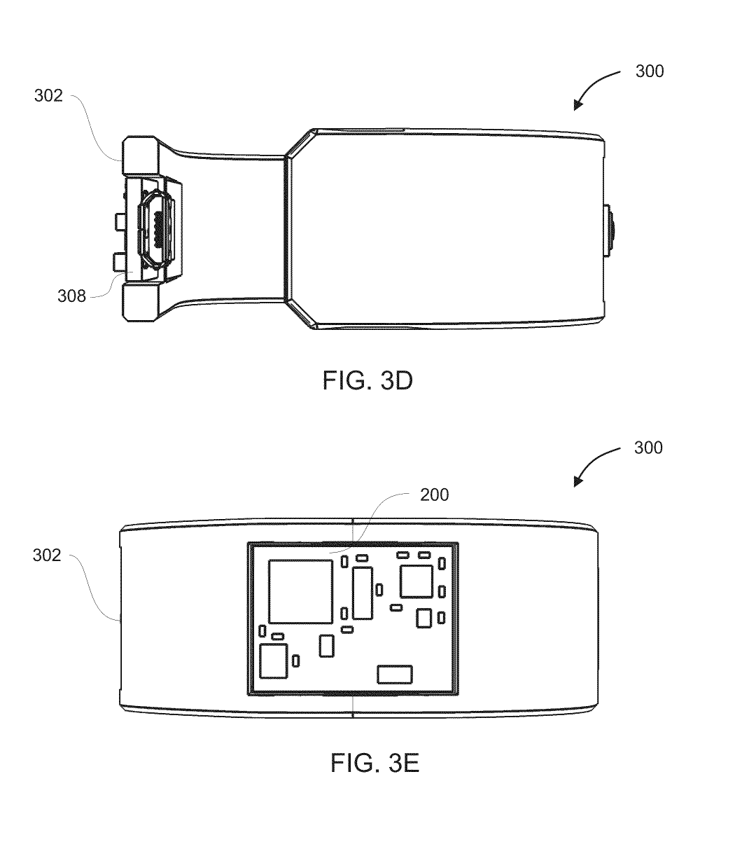

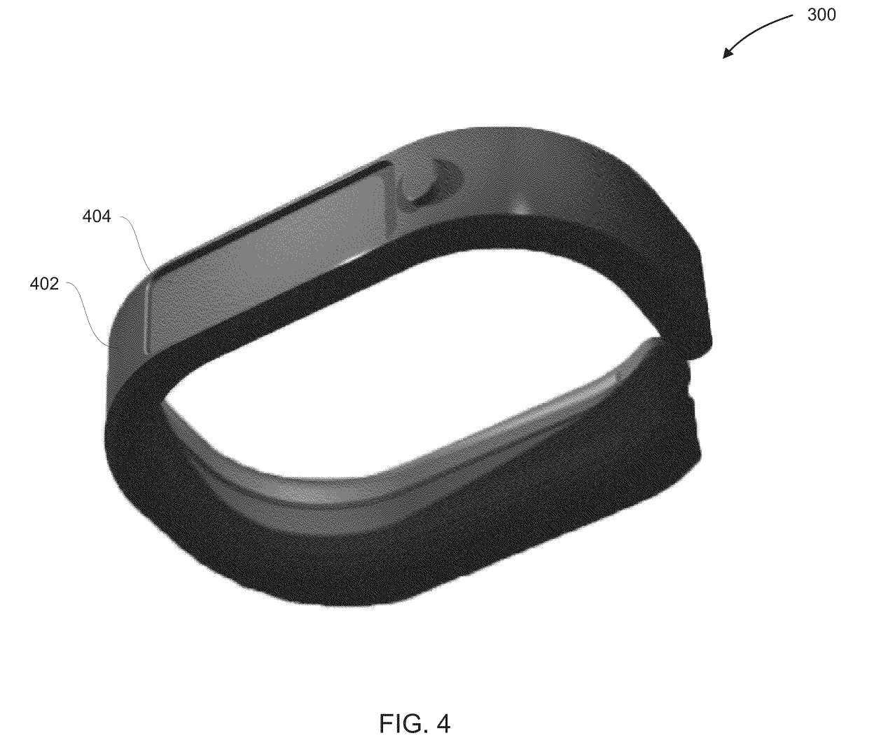

In some embodiments, the wearable device 104 is constructed to be worn by a user 102 for an extended period of time (e.g., for the duration of an event). In these embodiments, the wearable device is constructed to receive input from the user 102, provide notifications to the user 102, and monitor one or more parameters associated with the user 102. An example wearable device 104 is described further below with reference to the Example Wearable Device section, FIGS. 3A-E, and FIG. 4.

In some embodiments, the wearable device 104 collects information associated with the user 102 (e.g., user information). This user information may include, but is not limited to, user motion, body temperature, galvanic skin response, location, blood pressure, heart rate, ambient temperature, and sound. In these embodiments, the user information is collected via one or more sensors integrated with, or integral to, the wearable device 104.

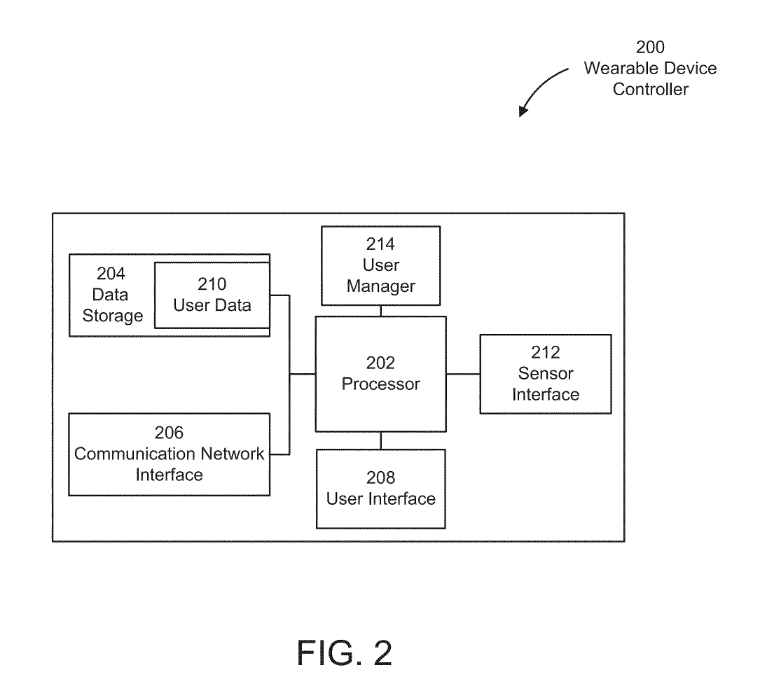

In various embodiments, the user information is collected from one or more sensors by a wearable device controller housed within the wearable device 104. In at least one embodiment, both the wearable device controller and the wearable device 104 may be configured to allow the wearable device controller to be safely and easy removed from the wearable device 104. In another embodiment, the wearable device controller is in connection with one or more input devices (e.g., one or more sensors) and output devices (e.g., an LED display). An example wearable device controller in accord with the embodiments described above is discussed further below with reference to the Wearable Device Controller section and FIG. 2.

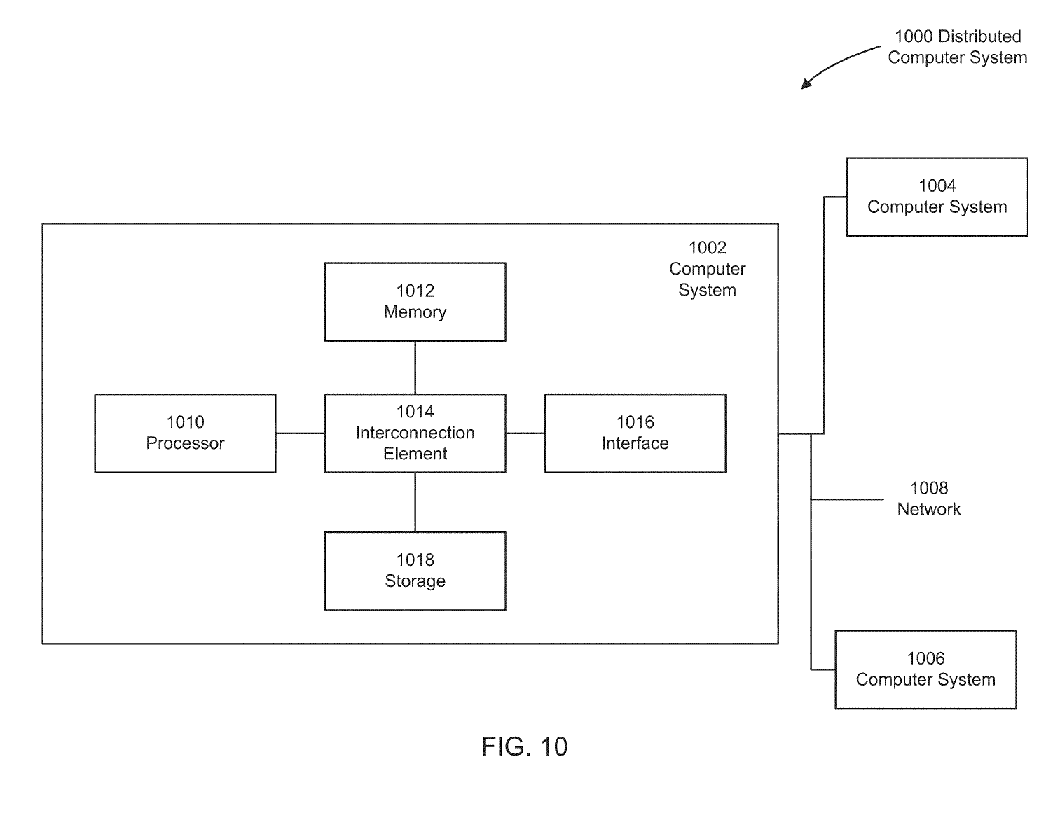

In some embodiments, the wearable device 104 is in communication with a reader 108 via a device-reader link 106. In these embodiments, the reader 108 transmits information collected from one or more wearable devices 108 to a server system 112 via one or more server-reader links 110. An example computer system is illustrated below with reference to the Computer System section and FIG. 10. It is appreciated that the functionality of the reader 108 may be combined with the functionality of the server system 112 described herein to obviate the server-reader link 110. In addition, the device-reader link 106 does not have to be a direct link between the wearable device 104 and the reader 108. For example, one or more wearable devices may be daisy chained and pass user information through one or more other wearable devices 104 prior to reaching a reader 108. In other examples, one or more readers 108 are daisy chained to pass information gathered from one or more wearable devices through one or more readers 108.

In one embodiment, the reader 108 is a mobile computing device (e.g., a tablet computer) with Bluetooth and Ethernet functionality. In this embodiment, the device-reader links 106 include messages that subscribe to a Bluetooth protocol, and the reader 108 communicates with the one or more wearable devices 104 using these messages. Further, in this embodiment, the user information from one or more wearable devices 104 is aggregated, encoded into messages that subscribe to an Ethernet protocol, and transmitted via the server-reader link 110 to the server system 112.

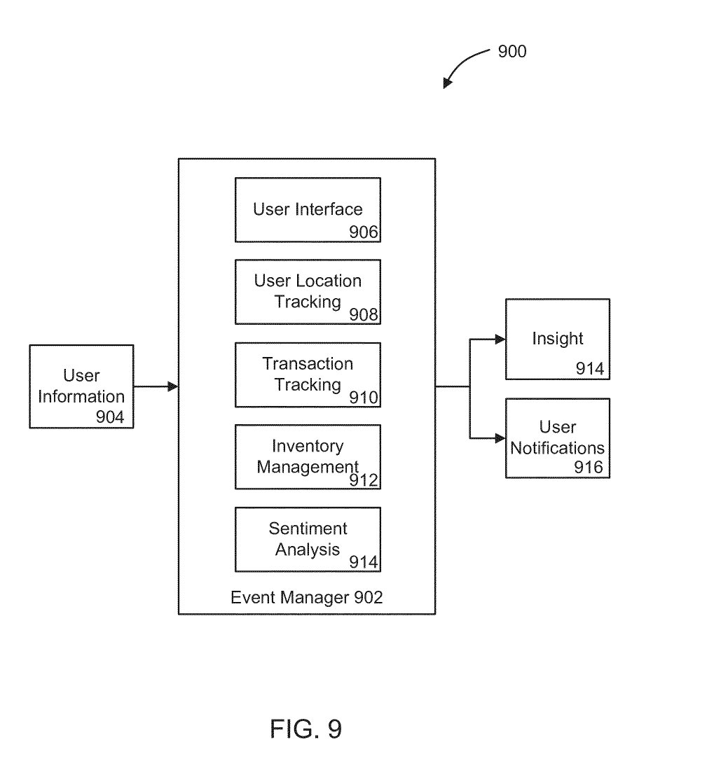

In various embodiments, the server system 112 compiles the information received from one or more readers 108. In these embodiments, the server system 112 executes an event manager that performs one or more operations to analyze the compiled data and/or issue notifications to users 102 (e.g., via the wearable device 104) as appropriate. An example event manager executed by the server system is illustrated below with reference to the Event Manager section and FIG. 9.

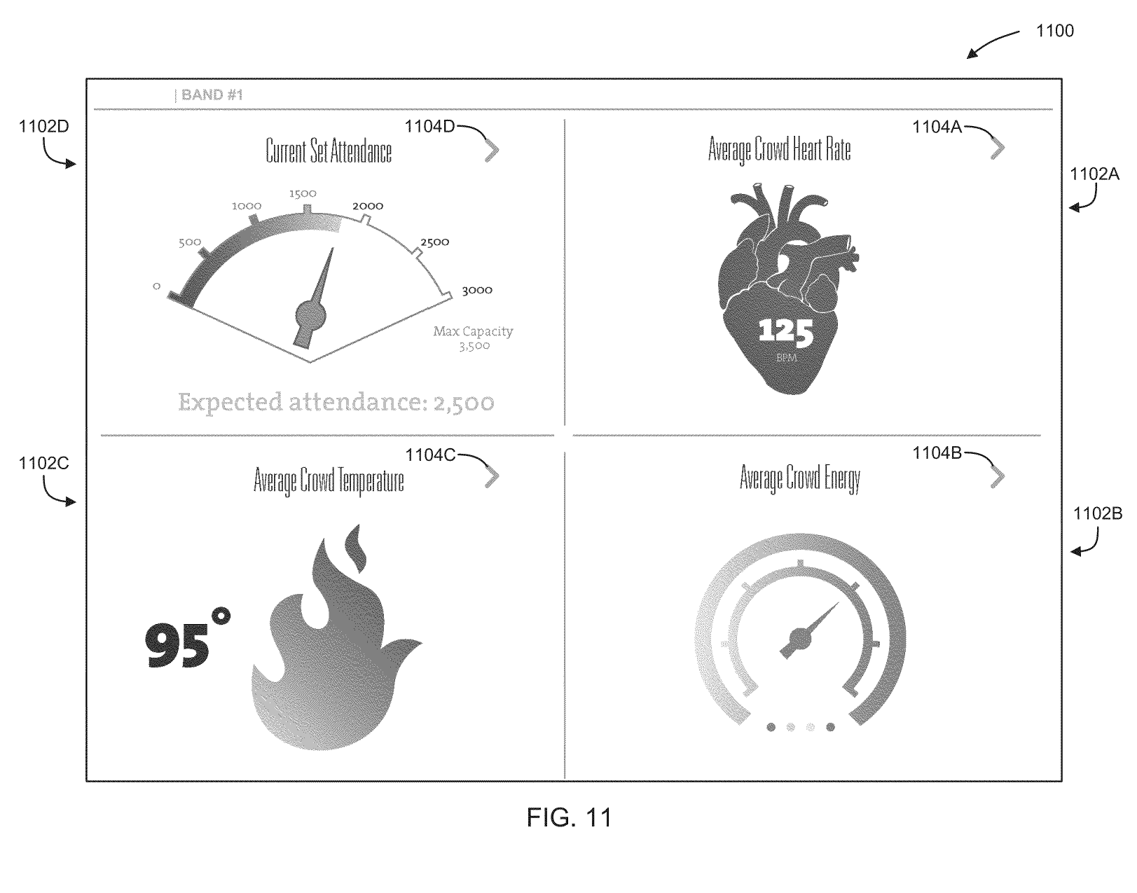

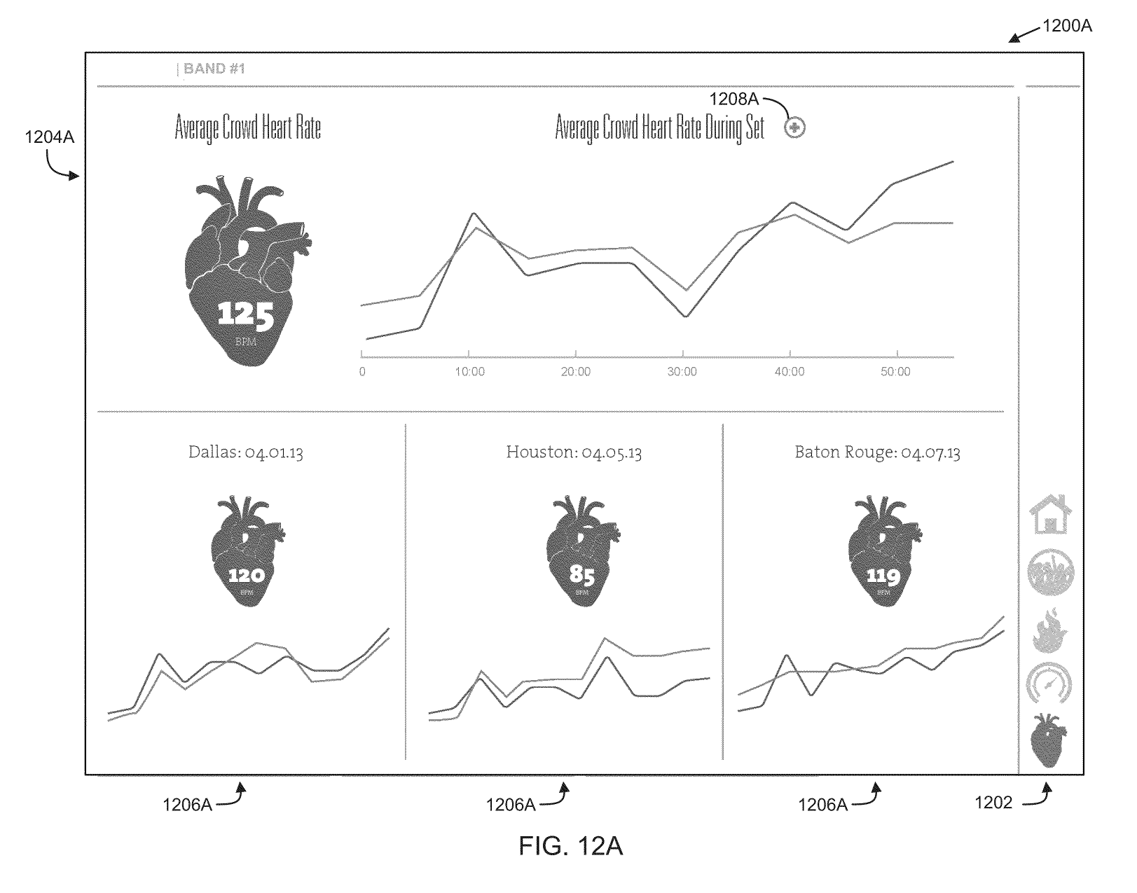

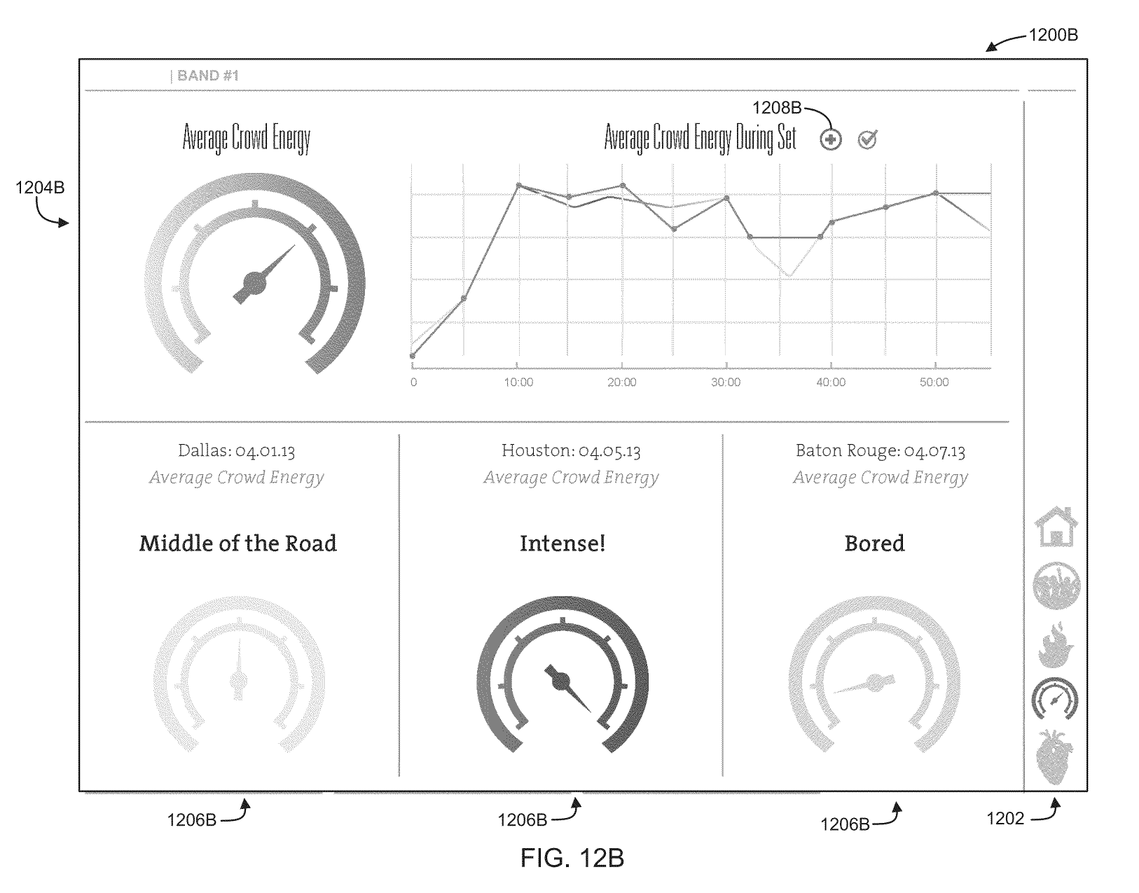

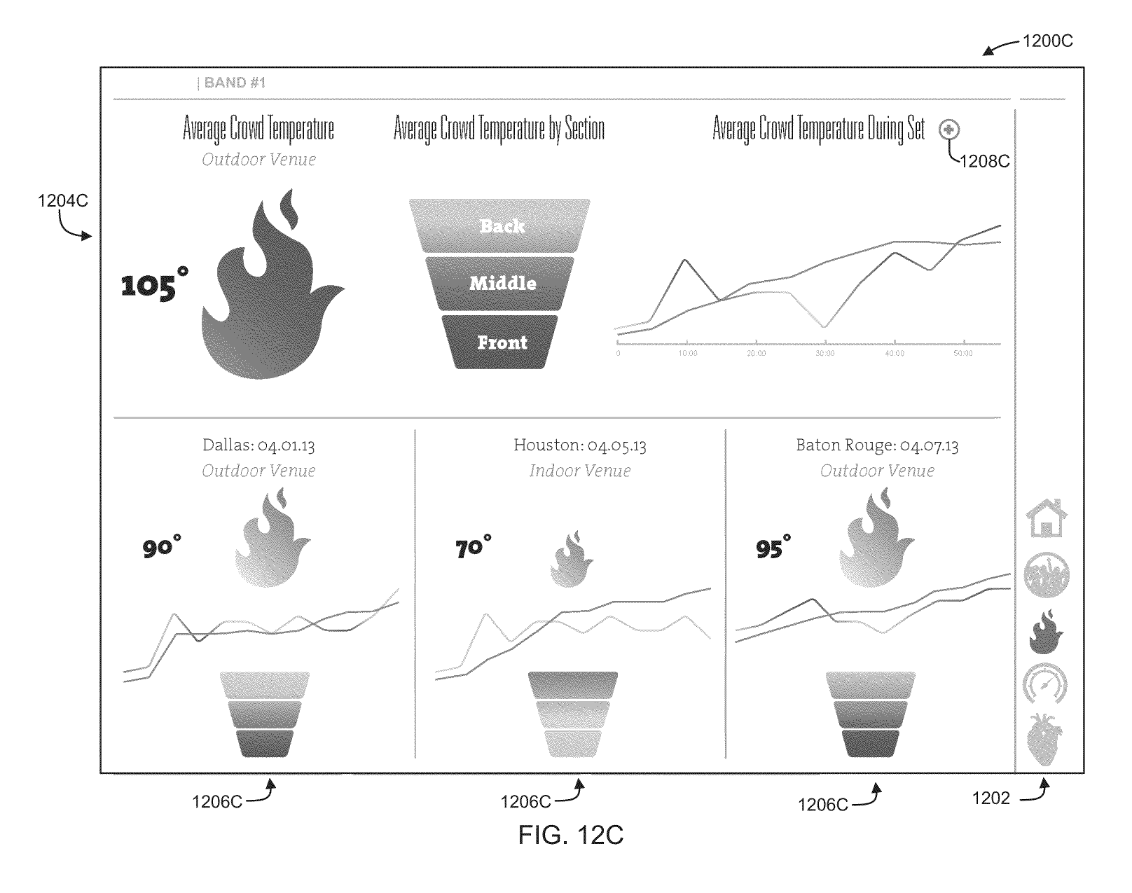

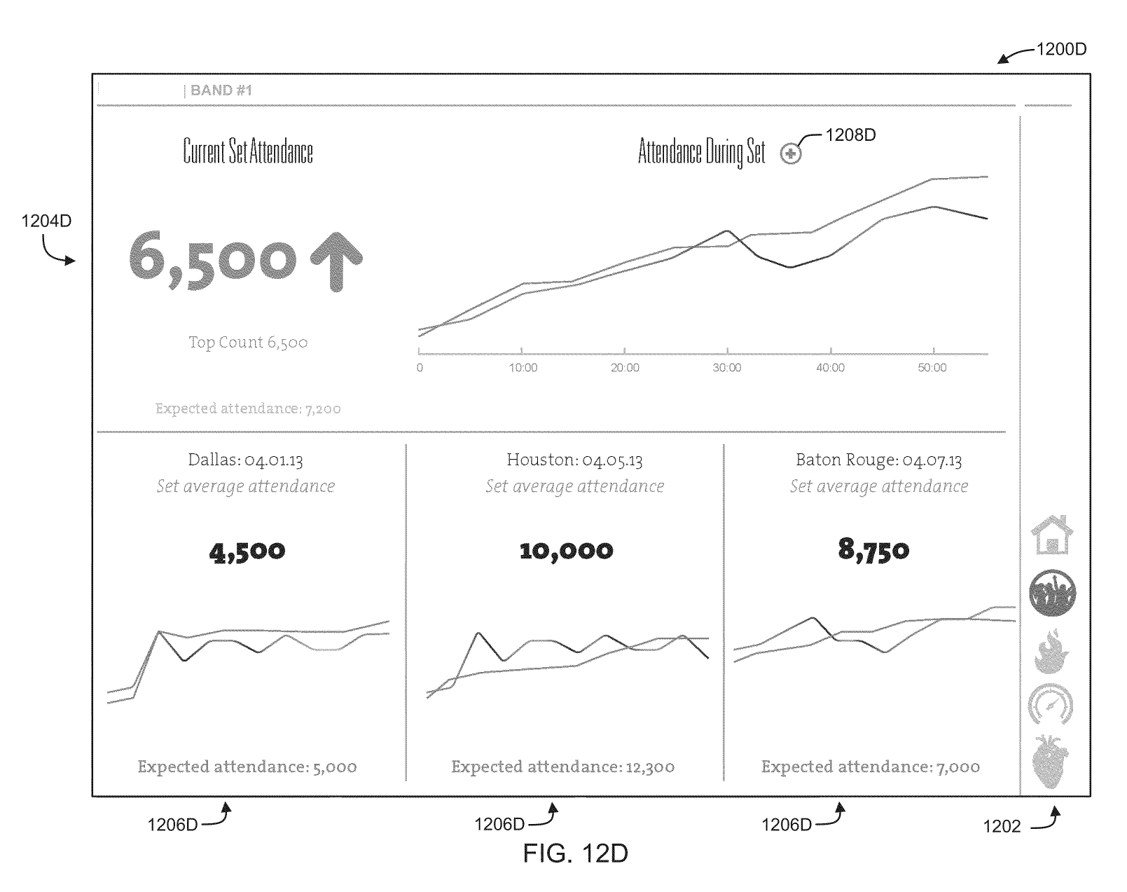

In some embodiments, the compiled and analyzed user information is sent to various client systems 116 via one or more client-server links 114. The client systems 116 may include computing devices (e.g., tablet computers, desktop computers, laptop computers, etc.) that present the compiled and aggregated information to information consumers (e.g., event constituents) consistent with one or more user interfaces. Example user interfaces for various types of information consumers are described further below with reference to the Event Manager User Interface section and FIGS. 11, 12A-D, 13, 14A-D, 15-16, and 17A-C.

In various embodiments, the event management system 100 receives input from information consumers and issues notifications to the various wearable devices 104 and their users 102 where appropriate. The information consumer input may be received via a user interface or through preset functions defined by an information consumer in the event management system 100. For example, an information consumer may choose to send one or more users 102 a discount on a product or service at an event. In these embodiments, the notifications are received and processed by a wearable device controller of the wearable device 102.

### Wearable Device Controller

FIG. 2 illustrates a wearable device controller 200 that is configured to collect user information, issue relevant user notifications, and communicate with an external system via one or more communication links. As shown in FIG. 2, the wearable device controller 200 comprises a processor 202, a sensor interface 212, a user manager 214, data storage 204 storing user data 210, a communication network interface 206, and a user interface 208.

According to the embodiment illustrated in FIG. 2, the processor 202 is coupled to the sensor interface 212, the data storage 204, the network interface 206, and the user interface 208. The processor 202 performs a series of instructions that result in manipulated data which are stored in and retrieved from the data storage 204. According to a variety of examples, the processor 202 is a commercially available processor such as a processor manufactured by Texas Instruments, Intel, AMD, Sun, IBM, Motorola, and ARM Holdings. Other example processors include processors from the Texas Instruments 8051 family of microprocessors. However, the processor 202 may be any type of processor, multiprocessor or controller, whether commercially available or specially manufactured.

In addition, in several embodiments the processor 202 is configured to execute a conventional real-time operating system (RTOS), such as RTLinux. In these examples, the RTOS may provide platform services to application software, such as some examples of the user manager 214 which is discussed further below. These platform services may include inter-process and network communication, file system management, and standard data store manipulation. One or more of many operating systems may be used, and examples are not limited to any particular operating system or operating system characteristic. For instance, in some examples, the processor 202 may be configured to execute a non-real time operating system, such as BSD or GNU/Linux. It is appreciated that the processor 202 may execute an Operating System Abstraction Library (OSAL). For example, the processor 202 may execute an OSAL from Texas Instruments.

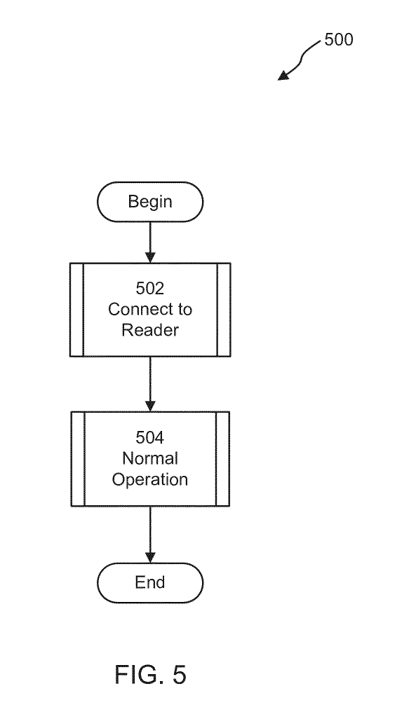

In some embodiments, the user manager 214 is configured to collect user information, issue relevant user notifications, and communicate with an external system (e.g., server system 112 of FIG. 1) via one or more communication links. Particular examples of the processes performed by the user manager 214 are discussed further below with reference to FIGS. 5-8 and within the Wearable Device Processes section.

The user manager 214 may be implemented using hardware or a combination of hardware and software. For instance, in one example, the user manager 214 is implemented as a software component that is stored within the data storage 112 and executed by the processor 202. In this example, the instructions included in the user manager 214 program the processor 202 to collect user information, issue relevant user notifications, and communicate with an external system (e.g., server system 112 of FIG. 1) via one or more communication links. In other examples, user manager 214 may be an application-specific integrated circuit (ASIC) that is coupled to the processor 202 and tailored to collect user information, issue relevant user notifications, and communicate with an external system (e.g., server system 112 of FIG. 1) via one or more communication links. Thus, examples of the user manager 214 are not limited to a particular hardware or software implementation.

In some embodiments, the components disclosed herein, such as the user manager 214, may read parameters that affect the functions performed by the components. These parameters may be physically stored in any form of suitable memory including volatile memory, such as RAM, or nonvolatile memory, such as a flash memory or magnetic hard drive. In addition, the parameters may be logically stored in a propriety data structure, such as a database or file defined by a user mode application, or in a commonly shared data structure, such as an application registry that is defined by an operating system. In addition, some examples provide for both system and user interfaces, as may be implemented using the user interface 208, that allow external entities (e.g., a wearable device user) to modify the parameters and thereby configure the behavior of the components.

The data storage 204 includes a computer readable and writeable nonvolatile data storage medium configured to store non-transitory instructions and data. In addition, the data storage 204 includes processor memory that stores data during operation of the processor 202. In some examples, the processor memory includes a relatively high performance, volatile, random access memory such as dynamic random access memory (DRAM), static memory (SRAM) or synchronous DRAM. However, the processor memory may include any device for storing data, such as a non-volatile memory, with sufficient throughput and storage capacity to support the functions described herein. According to several examples, the processor 202 causes data to be read from the nonvolatile data storage medium into the processor memory prior to processing the data. In these examples, the processor 202 copies the data from the processor memory to the non-volatile storage medium after processing is complete. A variety of components may manage data movement between the non-volatile storage medium and the processor memory and examples are not limited to particular data management components. Further, examples are not limited to a particular memory, memory system, or data storage system.

The instructions stored on the data storage 204 may include executable programs or other code that can be executed by the processor 202. The instructions may be persistently stored as encoded signals, and the instructions may cause the processor 202 to perform the functions described herein. The data storage 204 also may include information that is recorded, on or in, the medium, and this information may be processed by the processor 202 during execution of instructions. The medium may, for example, be optical disk, magnetic disk or flash memory, among others, and may be permanently affixed to, or removable from, the wearable device controller 200.

In some embodiments, the user data 210 includes data used by the user manager 214 to collect user information, issue relevant user notifications, and communicate with a central computer system via one or more communication links. More particularly, according to the illustrated example, the user data 210 includes user information that identifies user parameters such as, but not limited to, user motion, body temperature, galvanic skin response, location, blood pressure, heart rate, ambient temperature, sound, and user configuration parameters.

As illustrated in FIG. 2, the user manager 214 and the user data 210 are separate components. However, in other examples, the user manager 214 and the user data 210 may be combined into a single component or re-organized so that a portion of the data included in the user manager 214. The single component may include, for example, executable code that causes the processor 202 to collect user information, issue relevant user notifications, and communicate with an external system (e.g., server system 112 of FIG. 1) via one or more communication links, resides in the user data 210, or vice versa. Such variations in these and the other components illustrated in FIG. 2 are intended to be within the scope of the embodiments disclosed herein.

The user data 210 may be stored in any logical construction capable of storing information on a computer readable medium including, among other structures, flat files, indexed files, hierarchical databases, relational databases or object oriented databases. These data structures may be specifically configured to conserve storage space or increase data exchange performance. In addition, various examples organize the user data 210 into particularized and, in some cases, unique structures to perform the functions disclosed herein. In these examples, the data structures are sized and arranged to store values for particular types of data, such as integers, floating point numbers, character strings, arrays, linked lists, and the like.

As shown in FIG. 2, the wearable device controller 200 includes several system interface components 206, 208, and 212. Each of these system interface components is configured to exchange (i.e., send or receive) data with one or more specialized devices that may be located within the housing of the wearable device controller 200 or elsewhere. The components used by the interfaces 206, 208, and 212 may include hardware components, software components or a combination of both hardware and software components. Within each interface, these components physically and logically couple the wearable device controller 200 to the specialized devices. This physical and logical coupling enables the wearable device controller 200 to both communicate with and, in some instances, power or control the operation of the specialized devices. These specialized devices may include sensors, displays, and computer networking devices.

According to various examples, the hardware and software components of the interfaces 206, 208, and 212 implement a variety of coupling and communication techniques. In some examples, the interfaces 206, 208, and 212 use leads, cables or other wired connectors as conduits to exchange data between the wearable device controller 200 and specialized devices. In other examples, the interfaces 206, 208, and 212 communicate with specialized devices using wireless technologies such as radio frequency or infrared technology. The software components included in the interfaces 206, 208, and 212 enable the processor 202 to communicate with specialized devices. These software components may include elements such as objects, executable code, and populated data structures. Together, these software components provide software interfaces through which the processor 202 can exchange information with specialized devices. Moreover, in at least some examples where one or more specialized devices communicate using analog signals, the interfaces 206, 208, and 212 further include components configured to convert analog information into digital information, and vice-versa, to enable the processor 202 to communicate with specialized devices.

As discussed above, the system interface components 206, 208, and 212 shown in the example of FIG. 2 support different types of specialized devices. For instance, the components of the sensor interface 212 couple the processor 202 to one or more sensors such as a body temperature sensor, an accelerometer, a skin electrical conductivity sensor, an ambient temperature sensor, and an audio sensor.

The components of the network interface 206 couple the processor 202 to a computer network via a networking device, such as a bridge, router, hub, or a reader (e.g., reader 108). According to a variety of examples, the network interface 206 supports a variety of standards and protocols, examples of which include USB (via, for example, a dongle to a computer), TCP/IP, Ethernet, Wireless Ethernet, Bluetooth, ZigBee, M-Bus, CAN-bus, IP, IPV6, UDP, DTN, HTTP, FTP, SNMP, CDMA, NMEA and GSM. To ensure data transfer is secure, in some examples, the wearable device controller 200 can transmit data via the network interface 206 using a variety of security measures including, for example, TLS, SSL or VPN. In other examples, the network interface 206 includes both a physical interface configured for wireless communication and a physical interface configured for wired communication.

Thus, the various system interfaces incorporated in the wearable device controller 200 allow the device to interoperate with a wide variety of devices in various contexts. For instance, some examples of the wearable device controller 200 are configured to perform a process of exchanging data with a server via the network interface 206.

The user interface 208 shown in FIG. 2 includes a combination of hardware and software components that allow the wearable device controller 200 to communicate with an external entity, such as a wearable device user. These components may be configured to receive information from actions such as physical movement or voice commands. For example, the wearable device may accept a plurality of gestures performed by the user as input to navigate through options, verify a purchase, or release user data. Example components that may be employed within the user interface 208 includes accelerometers, microphones, electrodes, touch screens, display screens, speakers, LEDs, and buttons.

The wearable device controller 200 has a variety of potential applications and is well suited to devices that collect user information, issue relevant user notifications, and communicate with an external system via one or more communication links. For example, the wearable device controller may be housed within a wearable device worn by an event attendee in an event management system. In this example, the controller may exchange information with external entities to gain access to the event and specified areas within the event, complete financial transactions, and sign-up for contests.

### Example Wearable Device

FIGS. 3A-E and FIG. 4 illustrate a wearable device 300 that is constructed to collect user information, issue relevant user notifications, and exchange information with external entities via one or more communication links. As shown in FIGS. 3A-E, the wearable device 300 includes a support structure 302 that houses an LED display screen 304 comprising a plurality of LED's 306, power circuitry 308, and a wearable device controller 200. FIG. 4 illustrates a wearable device 300 that further includes a support structure cover 402 in addition to an LED display screen cover 404.

As illustrated in FIG. 3A, the support structure 302 is a band constructed to enable an individual to wear the device around their wrists. It is appreciated that the support structure is not limited to a wearable band worn around the wrist of a user. For example, in other embodiments the support structure includes a pair of glasses, a belt buckle, a headband, and a ring. It is appreciated that various parts of the body move differently and, therefore, gesture recognition processes may need to be altered based upon the support structure employed. For example, the detected user motion via an accelerometer while a user is running is different when the wearable device is worn around a user's head instead of their wrist. In addition, the wearable device 300 may include a support structure cover 402 as illustrated in FIG. 4 to make the wearable device 300 more comfortable to wear for an extended period of time.

The support structure houses an LED display 304. In some embodiments, the LED display comprises a plurality of LEDs 306 spaced in pre-defined intervals on a printed circuit board (PCB) operatively connected to the wearable device controller 200. It is appreciated that the LED display 304 may include one or more systems to translate information received from the wearable device controller into specific actions. For example, in one embodiment the wearable device controller transmits information regarding a specific sequence of characters to display to the user. In this embodiment, the LED display 304 translates the received sequence of characters into a specific intensity setting associated with each LED 306 of the LED display 304. In addition, the LED display may compensate for various environmental or wearable device status factors. For example, the LED display may alter the intensity of the LEDs based on the ambient light or the current time of day. In other examples, the LEDs are dimmed responsive to a detection of a low battery charge level. In another embodiment, the wearable device controller controls each LED 306 of the LED display 304 individually. In various embodiments, the LED display 306 is configured to display any text and/or numbers displayed in color on a white background to improve readability when compared to screens with white text and/or numbers on a dark background. It is appreciated that an LED display screen cover 404 may be fitted over the LED display 304 as illustrated in FIG. 4.

The power circuitry 308 monitors and controls the on-board power system of the wearable device. In some embodiments, the power system may include a rechargeable battery constructed to continuously operate the device for 24 hours. The rechargeable battery may include, for example, a lithium-ion battery, a nickel-metal hydride battery, or a nickel-cadmium battery. In these embodiments, the power circuitry monitors includes a battery connection and a corresponding charging unit to receive and condition power to charge the battery. It is appreciated that functionality of one or more sensors may be integrated with the power circuitry 308. For example, a galvanic skin response sensor and its corresponding circuitry may be integrated with the power circuitry 308.

In other embodiments, the wearable device 300 includes sensor circuitry that reads information from a plurality of sensors. The plurality of sensors may include, for example, one or more physiological sensors, such as, a body temperature sensor, an accelerometer, a skin electrical conductivity sensor, one or more environmental sensors such as ambient temperature sensors, audio sensors, and GPS locators. The physiological sensors may, for example, measure the oscillation of the arteries as the blood presses against the artery walls. In some embodiments, the physiological sensors are located on the inside of the support structure to come in contact with the skin of a user wearing the wearable device. The sensing circuitry may aggregate at least a portion of the user information for transmission to the wearable device controller.

In one embodiment, the wearable device controller 200 illustrated in FIGS. 3A-E is removably housed in the wearable device. In this embodiment, the wearable device controllers 200 of various wearable devices 300 can be interchanged. The memory storing information relevant to the user is maintained on the device controller 200 within, for example, the non-volatile memory.

### Wearable Device Processes

Various embodiments implement and enable processes through which a wearable device controller collects user information, issues relevant user notifications, and communicates with an external system via one or more communication links. FIG. 5 illustrates one such process 500 that includes acts of connecting to a reader 502 and entering normal operation 504.

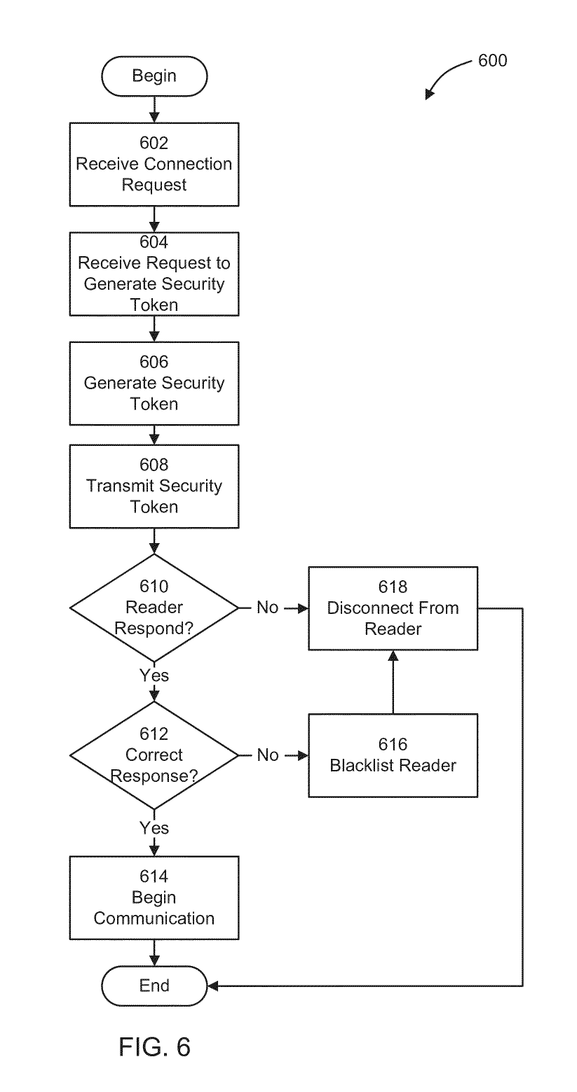

In act 502, the wearable device controller connects to a reader. The wearable device controller may complete one or more verification processes during act 502. Actions performed by the wearable device controller during execution of act 502 are described further below with reference to FIG. 6.

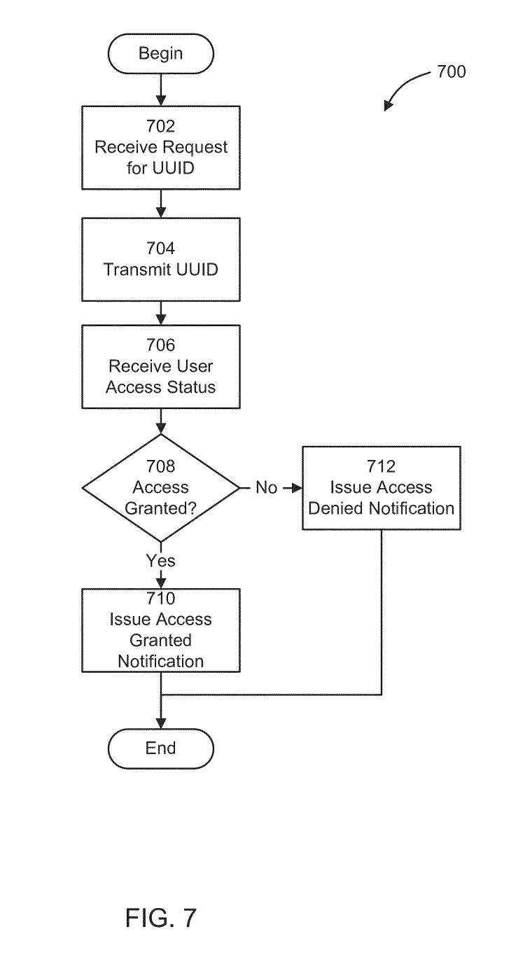

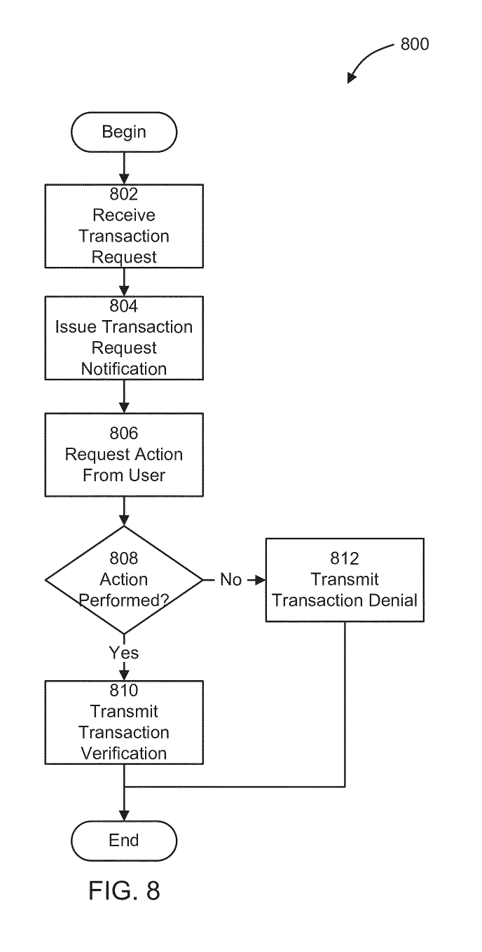

In the act 504, the wearable device controller begins normal operation. The wearable device may perform any number of processes while in normal operation. These processes may include, but are not limited to, ticket validation processes and transaction verification processes. Actions performed by the wearable device controller during execution of an example ticket validation process are described further below with reference to FIG. 7. In addition, actions performed by the wearable device controller during execution of an example transaction verification process are described further below with reference to FIG. 8.

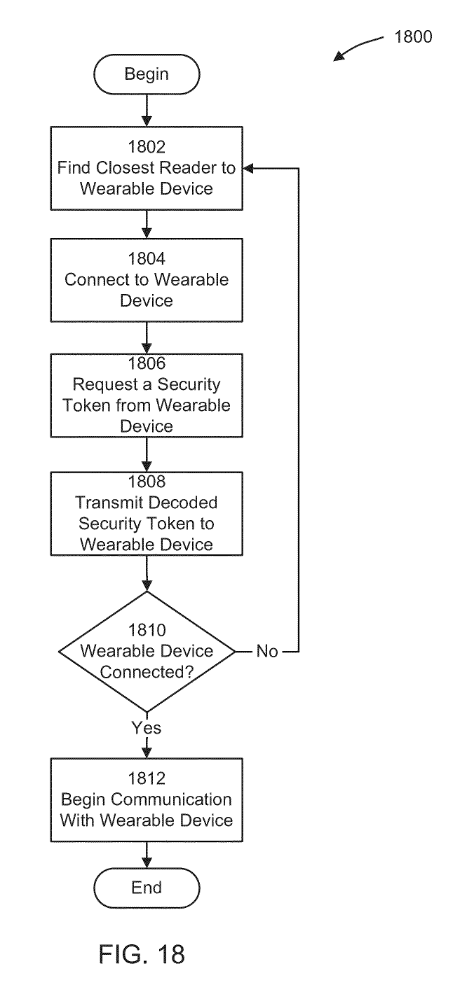

As discussed above with regard to act 502 in FIG. 5, various embodiments implement processes for connecting to a reader. In some embodiments, the wearable device is discoverable by a reader communicatively coupled with a server system (e.g., reader 108 and server system 112). In these embodiments, the server system performs wearable device connection processes described below with reference to the Event Manager Processes section and FIG. 18. FIG. 6 illustrates one such reader connection process 600 performed by the wearable device to complete the connection process initiated by the server system. The reader connection process 600 includes the acts of receiving a connection request 602, receiving a request to generate a security token 604, generating a security token 606, transmitting the security token 608, determining whether the reader responded 610, determining whether the response from the reader was correct 612, beginning communication 614, blacklisting the reader 616, and disconnecting from the reader 618.

In act 602, the wearable device controller receives a request from a reader to establish a communication link. The request to establish a communication link may include or be followed by a request to generate a security token as illustrated in act 604. In response, the wearable device controller generates a token in act 606 and transmits the security token in act 608 to the reader. In act 610, the wearable device determines whether the reader responded to the security token transmission in act 608. In some embodiments, this determination is made by waiting a predetermined period of time for a response (e.g., 1 second) from the reader. If the wearable device receives a response, the wearable device determines whether the received response was correct in act 612. Otherwise, the wearable device disconnects from the reader in act 618. It is appreciated that the same or a different reader may initiate a new connection request after disconnecting from a reader in act 618 and thereby cause process 600 to be repeated with the same or a different reader.

Referring back to act 612 of determining whether the received response was correct, in one embodiment the wearable device controller determines whether the received response was correct by comparing a received response to a value stored in the memory. If the received value matches the stored value, the response is verified and the wearable device may continue to act 614 and begin communication. Otherwise, the reader is blacklisted in act 616 and disconnected from the wearable device in act 618. Blacklisting the reader may include, for example, storing identification information associated with the reader in memory and refusing future connection requests received from the reader. It is appreciated that the identification information associated with the blacklisted reader in memory may be transmitted after successfully connecting to a reader. For example, the wearable device may transmit the identification information (e.g., the media access control address) of the blacklisted reader to the server system (e.g., server system 112) to alert the server system of a malfunctioning reader.

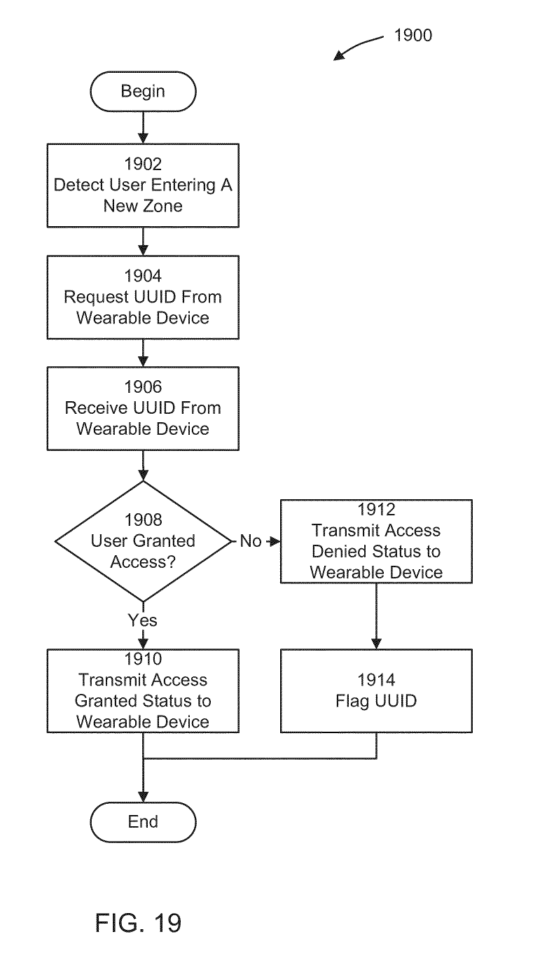

As discussed above with regard to act 504 in FIG. 5, various embodiments implement processes for validating user entry into a restricted area (e.g., a concert). In some embodiments, the wearable device location is tracked by a server system (e.g., server system 112). In these embodiments, the server system performs user location verification processes described below with reference to the Event Manager Processes section and FIG. 19. FIG. 7 illustrates one such user entry validation process 700 performed by the wearable device to complete the verification process initiated by the server system. The user entry validation process 710 includes acts of receiving a request for a universally unique identifier (UUID) 702, transmitting the UUID 704, receiving a user access status 706, determining whether access was granted 708, issuing an access granted notification 710, and issuing an access denied notification 712.

In act 702, the wearable device controller receives a request for a UUID from an external system (e.g., from the server system 112 via a reader 108 in FIG. 1). In response, the wearable device controller transmits its UUID to the external system. The wearable device controller receives a user access status in act 706. The wearable device controller reads the received user access status and determines whether access was granted or denied in act 708. If access was granted, the wearable device controller issues an access granted notification in act 710. The access granted notification may include, for example, flashing one or more LEDs of the LED display 304 green. Otherwise, the wearable device controller issues an access denied notification in act 712. The access denied notification may include, for example, flashing one or more LEDs of the LED display 304 red.

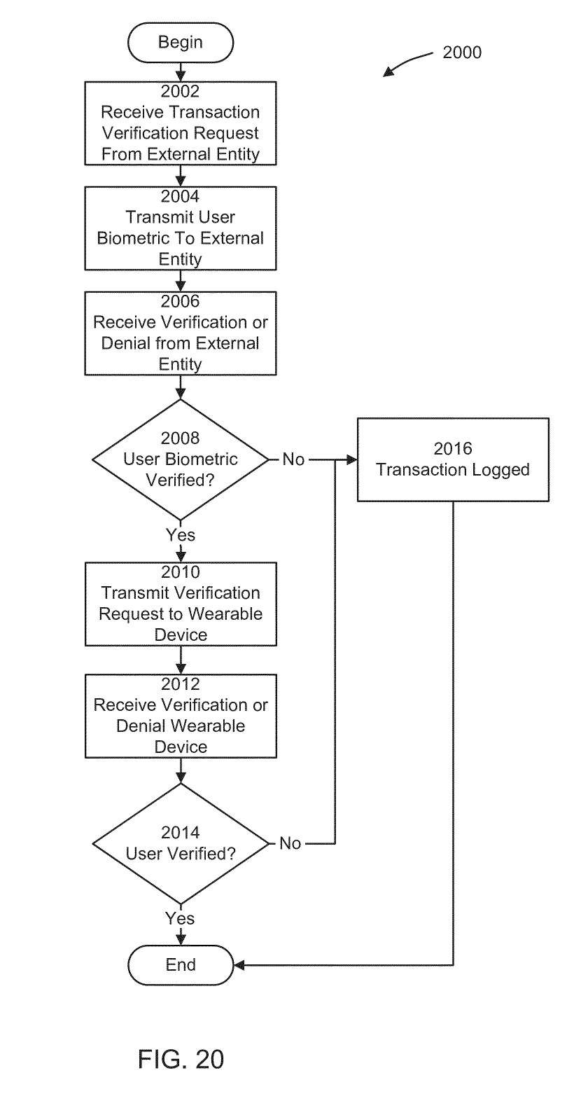

As discussed above with regard to act 504 in FIG. 5, various embodiments implement processes for verifying transactions associated with the user (e.g., a user purchasing food). In some embodiments, the transaction request is received by a server system communicatively coupled with the wearable device (e.g., server system 112 via a reader 108). In these embodiments, the server system performs transaction verification processes described below with reference to the Event Manager Processes section and FIG. 20. FIG. 8 illustrates one such user transaction verification process 800 implemented by the wearable device to complete the transaction verification process initiated by the server system. The transaction verification process 800 includes the acts of receiving a transaction request 802, issuing a transaction request notification to the user 804, requesting an action from the user 806, determining whether the action was performed 808, transmitting transaction verification 810, and transmitting transaction denial 812.

In act 802, the wearable device controller receives a transaction request from an external system (e.g., from the server system 112 in FIG. 1). In response, the wearable device controller issues a transaction request notification to the user in act 804. The wearable device controller may request action from the user in act 806. It is appreciated that acts 804 of issuing a transaction request notification and 806 of requesting action from the user may be combined into a single act. In addition, the specific action requested for the user to perform by the wearable device controller may have been pre-configured by the user configurable. For example, in one embodiment the user pre-configured the action associated with authorizing a transaction to be a finger snap. In other examples, the specific action may be a specific dance move.

In act 808, the wearable device controller determines whether the user performed the requested action. If the wearable device controller detects that the correct action was performed, the wearable device controller continues to act 810 and transmits a transaction verification to the external system. Otherwise, the wearable device controller continues to act 812 and transmits a transaction denial to the external system.

The wearable device and its wearable device controller described herein operate within an event management system as described with reference to the event management system and FIG. 1. It is appreciated that one or more system managers, such as an event manager, may be executed by the server system 112 to aggregate, analyze, and output information from the wearable devices.

### Event Manager

According to one aspect, it is realized that benefits can be obtained by providing user information to various information consumers associated with an event (e.g., artists, promoters, venue owners, etc.). One such aspect is provided by an event manager executed on a server system 112 illustrated in FIG. 1. The event manager 902 is configured to receive user information 904, for example, through wearable devices 104 illustrated in FIG. 1. The user information 904 may contain information to aid the event manager 902 in generating an appropriate insight 914 that is directly relevant to at least one type of information consumer. In the field of concert performances, for example, insight 914 may include an estimated energy level of the crowd. The insight 914 may be presented in accordance with one or more user interfaces 906. It is appreciated that user interfaces 906 may be tailored to each specific type of information consumer. Example user interfaces are described further below with reference to the User Interfaces section and FIGS. 11A-E, 12A-E, and 13A-E. In addition, the event manager 902 may generate notifications 916 to interact with the wearable device users.

It is appreciated that information presented to the information consumers may be presented anonymously. Presenting information (e.g., biometric information) anonymously to information consumers may include presenting information in a fashion that precludes the information consumer from uniquely identifying the source individual of the information. In addition, the information may be received by the event manager 902 anonymously and thereby preclude the event manager 902 from uniquely identifying source individuals of information. For example, in one embodiment the server system (e.g., server system 112) may assign a random connection sequence number to each wearable device (e.g., wearable device 104). The first reader (e.g., reader 108) in communication with the wearable device transmits the random connection sequence number to the wearable device. Each time the wearable device connects to a new a reader, it is issued a new random connection sequence number. In addition, readers may insert user information from fabricated wearable devices into the aggregated user information sent to the server system. The introduction of user information from fabricated wearable devices may occur in response to the number of wearable devices dropping below a preset threshold (e.g., ten wearable devices). The user information from the fabricated wearable devices may include benchmark biometric information (e.g., heart rate, blood pressure, etc.) and/or pseudo randomly generated biometric information.

The event manager 902 is further configured to leverage various system components to analyze the user information for presentation to various types of information consumers. As illustrated in FIG. 9, the system components include a user location tracking component 908, a transaction tracking component 910, an inventory management component 912, and a sentiment analysis component 914.

In one embodiment, the user information 904 received by the event manager 902 includes information received from a plurality of wearable device users (e.g., body temperature, location, etc.). This information may be descriptive of, for example, a sentiment and current location associated with each of the wearable device users. The received user information may be aggregated and analyzed by one or more components including the user location tracking component 908, the transaction tracking component 910, an inventory management component 912, and a sentiment analysis component 914.

In some embodiments, the location tracking component 908 computes an approximate location of the plurality of wearable devices and their corresponding users. The location of the plurality of wearable devices may be received directly from the wearable device or alternatively calculated by the event manager. The event manager may calculate the approximate location of the wearable devices by determining which reader is connected to each device and determining a received signal strength. The received signal strength may then be used to determine how far each wearable device is from any given reader. The calculated approximate distance from the reader may be used in combination with a known location of the reader to determine an approximate location of the various wearable devices.

In one embodiment, location information determined by the location tracking component 908 is made accessible to various information consumers via a user interface. For example, in one embodiment the location tracking component 908 estimates and displays to an information consumer how long wearable device users spend waiting in line for various activities (e.g., at the entrance to a concert, to use the restroom, to purchase food, etc.).

It is appreciated that the location tracking component is not limited to tracking wearable devices individually. In various embodiments, the location tracking component 908 monitors group behavior. Group behaviors may, for example, be identified by tracking groups of wearable devices that travel together.

In some embodiments, the transaction tracking component 910 tracks transactions between any wearable device user and a third party (e.g., an information consumer, a vendor, another wearable device user, etc.). These transactions may include, but are not limited to, financial transactions and contest registration transactions. Specific processes performed by the transaction tracking component are described with reference to the Event Manager Processes section and FIG. 20.

In some embodiments, the inventory management component 912 leverages information from the transaction component to manage inventory for one or more vendors. The inventory management component may accept input from a vendor indicating a total unit count of one or more products and update the product unit count based upon transactions processed by the transaction tracking component 910 of matching products from a matching vendor. It is appreciated that the event manager may include one or more electronic data interchanges (EDI) to communication with external systems (e.g., server systems for vendors, distributors, or manufactures). For example, transaction may be streamed to a vendor in real-time as the transactions are processes. In addition, alerts of low inventory may be sent to external systems via the EDI to notify the external system when inventory transgresses a threshold.

In some embodiments, the sentiment analysis component 914 aggregates and analyzes user information from the plurality of wearable device users. For example, the sentiment analysis component may determine an estimated energy level for each user based upon received or derived user information parameters (e.g., blood pressure, heart rate, skin conductance, and motion). In these embodiments, the aggregated and analyzed data is made available to various information consumers (e.g., artists, tour managers, event producers, etc.). In one example, specific notifications are issued to the artist in response to a determination that the sentiment of the crowd falls below a threshold level. The sentiment analysis component 914 may also correlate crowd sentiment with various activities within the performance (e.g., when specific songs are played) to aid artists increase the mass appeal of their performances.

In one embodiment, the sentiment analysis component 914 improves the sentiment of the crowd. The sentiment of the crowd may be improved, for example, by the sentiment analysis component by issuing notifications including vendor discounts (e.g., discounted alcohol) to the wearable device users. In addition, discounts can be tied to the execution of specific actions to gamify the process. For example, wearable device users may unlock vendor discounts by performing a “high-five” with another wearable device user. Other examples improving the crowd sentiment include leveraging the LED display of each wearable device and estimated locations of the various wearable devices to form a light show. It is appreciated that the light show may correlate to the performance of the artist. For example, the intensity of the light illuminated by the various wearable devices may correlate with a volume level of song during a musician's performance.

### Computer System

As discussed above with regard to FIG. 9, various aspects and functions described herein may be implemented as specialized hardware or software components executing in one or more computer systems. There are many examples of computer systems that are currently in use. These examples include, among others, network appliances, personal computers, workstations, mainframes, networked clients, servers, media servers, application servers, database servers and web servers. Other examples of computer systems may include mobile computing devices, such as cellular phones and personal digital assistants, and network equipment, such as load balancers, routers and switches. Further, aspects may be located on a single computer system or may be distributed among a plurality of computer systems connected to one or more communications networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Consequently, examples are not limited to executing on any particular system or group of systems. Further, aspects and functions may be implemented in software, hardware or firmware, or any combination thereof. Thus, aspects and functions may be implemented within methods, acts, systems, system elements and components using a variety of hardware and software configurations, and examples are not limited to any particular distributed architecture, network, or communication protocol.

Referring to FIG. 10, there is illustrated a block diagram of a distributed computer system 1000, in which various aspects and functions are practiced. As shown, the distributed computer system 1000 includes one more computer systems that exchange information. More specifically, the distributed computer system 1000 includes computer systems 1002, 1004 and 1006. As shown, the computer systems 1002, 1004 and 1006 are interconnected by, and may exchange data through, a communication network 1008. The network 1008 may include any communication network through which computer systems may exchange data. To exchange data using the network 1008, the computer systems 1002, 1004 and 1006 and the network 1008 may use various methods, protocols and standards, including, among others, Fibre Channel, Token Ring, Ethernet, Wireless Ethernet, Bluetooth, ZigBee, 6LoWPAN, IP, IPV6, TCP/IP, UDP, DTN, HTTP, FTP, SNMP, SMS, MMS, SS7, JSON, SOAP, CORBA, REST and Web Services. To ensure data transfer is secure, the computer systems 1002, 1004 and 1006 may transmit data via the network 1008 using a variety of security measures including, for example, TLS, SSL, AES, or VPN. While the distributed computer system 1000 illustrates three networked computer systems, the distributed computer system 1000 is not so limited and may include any number of computer systems and computing devices, networked using any medium and communication protocol.

As illustrated in FIG. 10, the computer system 1002 includes a processor 1010, a memory 1012, an interconnection element 1014, an interface 1016 and data storage element 1018. To implement at least some of the aspects, functions and processes disclosed herein, the processor 1010 performs a series of instructions that result in manipulated data. The processor 1010 may be any type of processor, multiprocessor or controller. Some exemplary processors include commercially available processors such as an Intel Xeon, Itanium, Core, Celeron, or Pentium processor, an AMD Opteron processor, an Apple A5, a Sun UltraSPARC or IBM Power5+ processor and an IBM mainframe chip. The processor 1010 is connected to other system components, including one or more memory devices 1012, by the interconnection element 1014.

The memory 1012 stores programs and data during operation of the computer system 1002. Thus, the memory 1012 may be a relatively high performance, volatile, random access memory such as a dynamic random access memory (“DRAM”) or static memory (“SRAM”). However, the memory 1012 may include any device for storing data, such as a disk drive or other non-volatile storage device. Various examples may organize the memory 1012 into particularized and, in some cases, unique structures to perform the functions disclosed herein. These data structures may be sized and organized to store values for particular data and types of data.

Components of the computer system 1002 are coupled by an interconnection element such as the interconnection element 1014. The interconnection element 1014 may include one or more physical busses, for example, busses between components that are integrated within a same machine, but may include any communication coupling between system elements including specialized or standard computing bus technologies such as IDE, SCSI, PCI and InfiniBand. The interconnection element 1014 enables communications, such as data and instructions, to be exchanged between system components of the computer system 1002.

The computer system 1002 also includes one or more interface devices 1016 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 1002 to exchange information and to communicate with external entities, such as users and other systems.

The data storage element 1018 includes a computer readable and writeable nonvolatile, or non-transitory, data storage medium in which instructions are stored that define a program or other object that is executed by the processor 1010. The data storage element 1018 also may include information that is recorded, on or in, the medium, and that is processed by the processor 1010 during execution of the program. More specifically, the information may be stored in one or more data structures specifically configured to conserve storage space or increase data exchange performance. The instructions may be persistently stored as encoded signals, and the instructions may cause the processor 1010 to perform any of the functions described herein. The medium may, for example, be optical disk, magnetic disk or flash memory, among others. In operation, the processor 1010 or some other controller causes data to be read from the nonvolatile recording medium into another memory, such as the memory 1012, that allows for faster access to the information by the processor 1010 than does the storage medium included in the data storage element 1018. The memory may be located in the data storage element 1018 or in the memory 1012, however, the processor 1010 manipulates the data within the memory, and then copies the data to the storage medium associated with the data storage element 1018 after processing is completed. A variety of components may manage data movement between the storage medium and other memory elements and examples are not limited to particular data management components. Further, examples are not limited to a particular memory system or data storage system.

Although the computer system 1002 is shown by way of example as one type of computer system upon which various aspects and functions may be practiced, aspects and functions are not limited to being implemented on the computer system 1002 as shown in FIG. 10. Various aspects and functions may be practiced on one or more computers having a different architectures or components than that shown in FIG. 10. For instance, the computer system 1002 may include specially programmed, special-purpose hardware, such as an application-specific integrated circuit (“ASIC”) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 1002 may be a computer system including an operating system that manages at least a portion of the hardware elements included in the computer system 1002. In some examples, a processor or controller, such as the processor 1010, executes an operating system. Examples of a particular operating system that may be executed include a Windows-based operating system, such as, Windows NT, Windows 10000 (Windows ME), Windows XP, Windows Vista or Windows 7 operating systems, available from the Microsoft Corporation, a MAC OS System X operating system available from Apple Computer, one of many Linux-based operating system distributions, for example, the Enterprise Linux operating system available from Red Hat Inc., a Solaris operating system available from Sun Microsystems, or a UNIX operating systems available from various sources. Many other operating systems may be used, and examples are not limited to any particular operating system.

The processor 1010 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, or C# (C-Sharp). Other object-oriented programming languages may also be used. Alternatively, functional, scripting, or logical programming languages may be used.

Additionally, various aspects and functions may be implemented in a non-programmed environment, for example, documents created in HTML, XML or other format that, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements (e.g. specialized hardware, executable code, data structures or objects) that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

### Event Manager User Interfaces

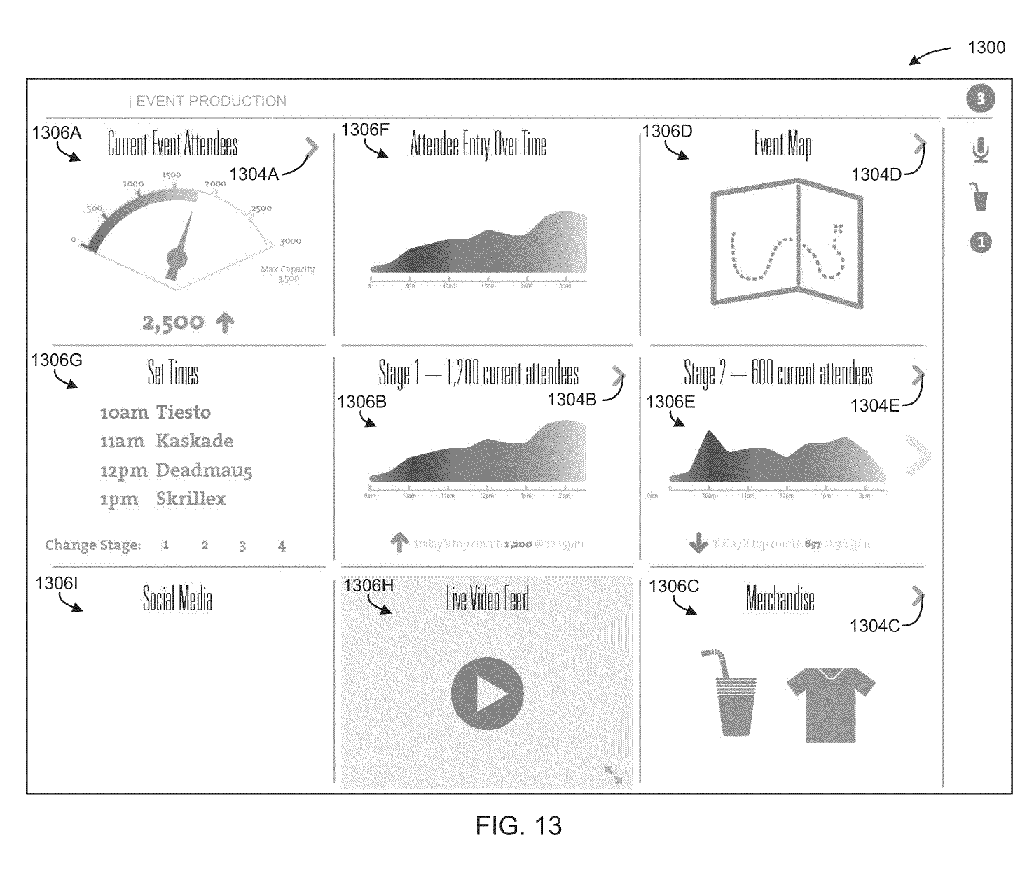

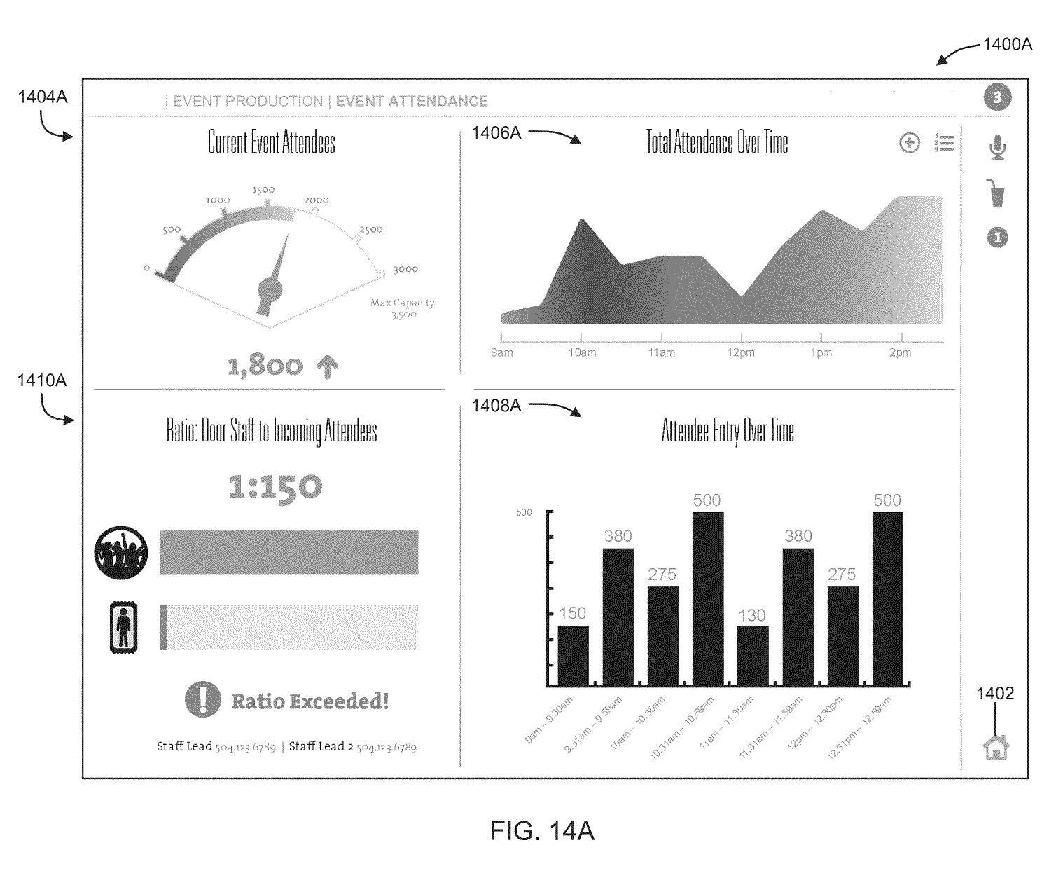

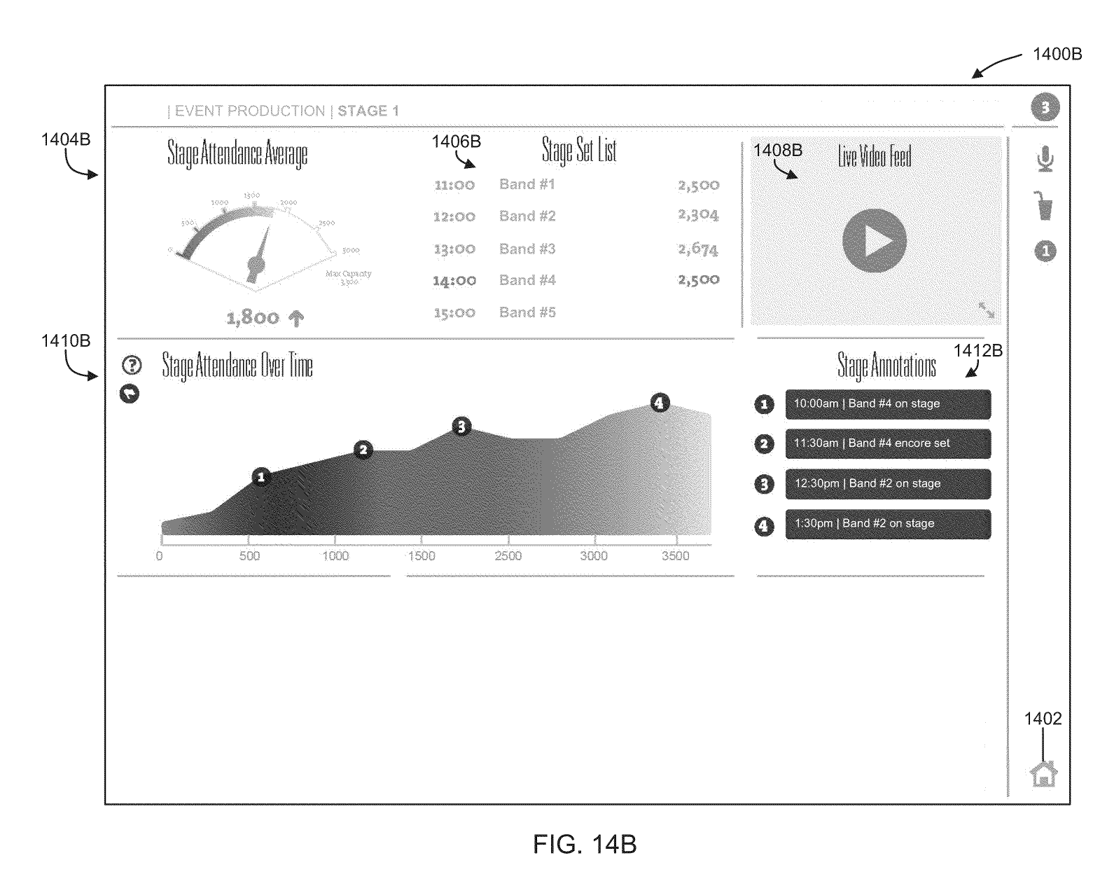

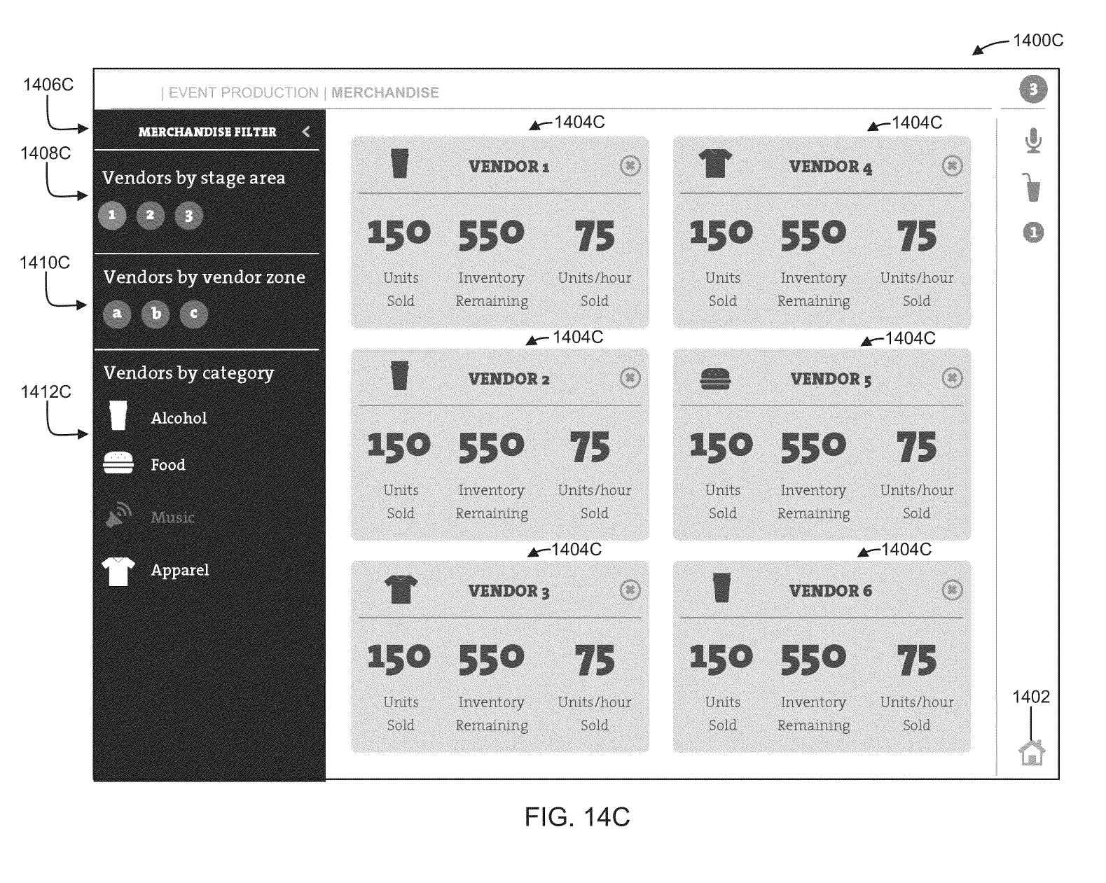

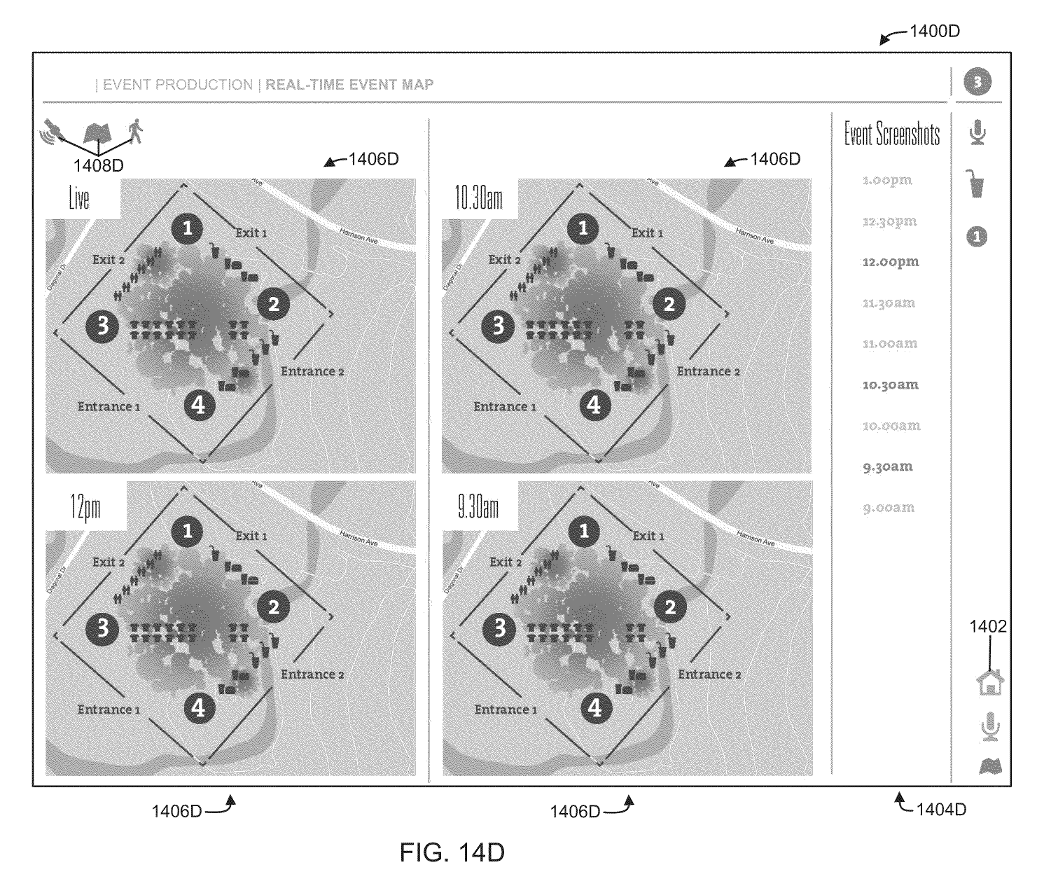

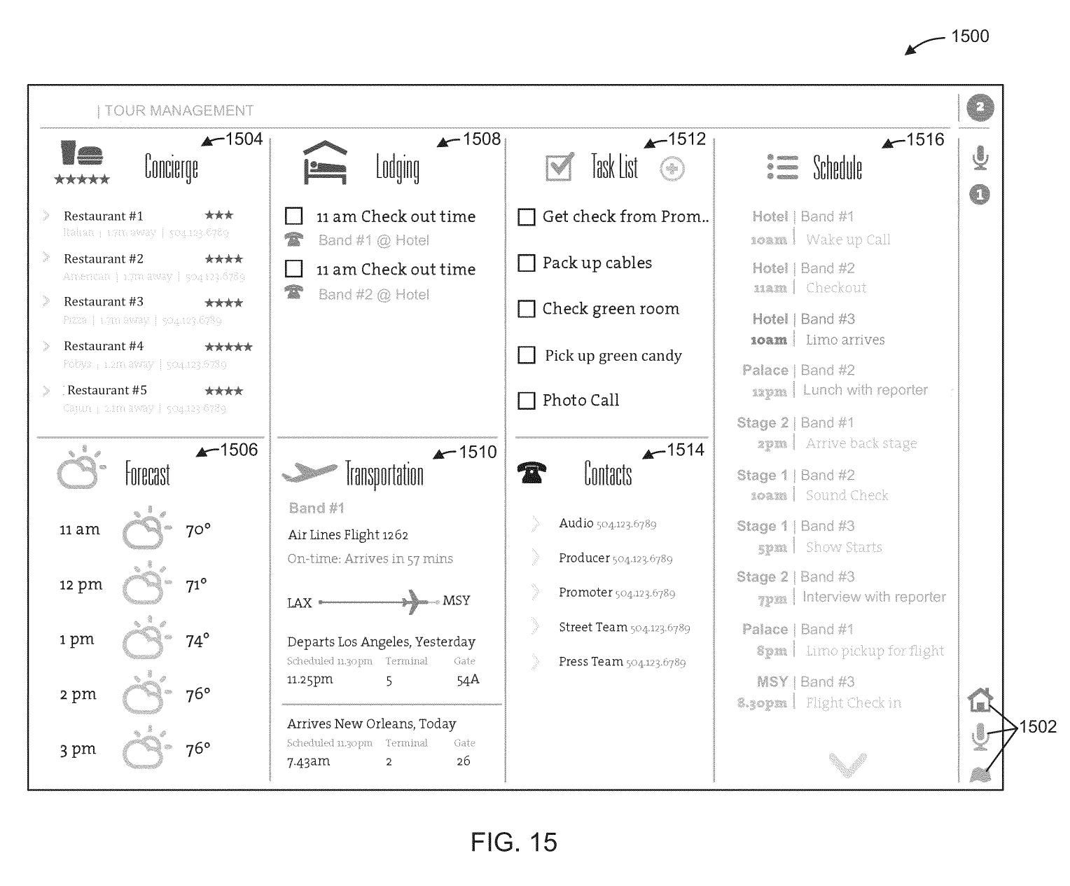

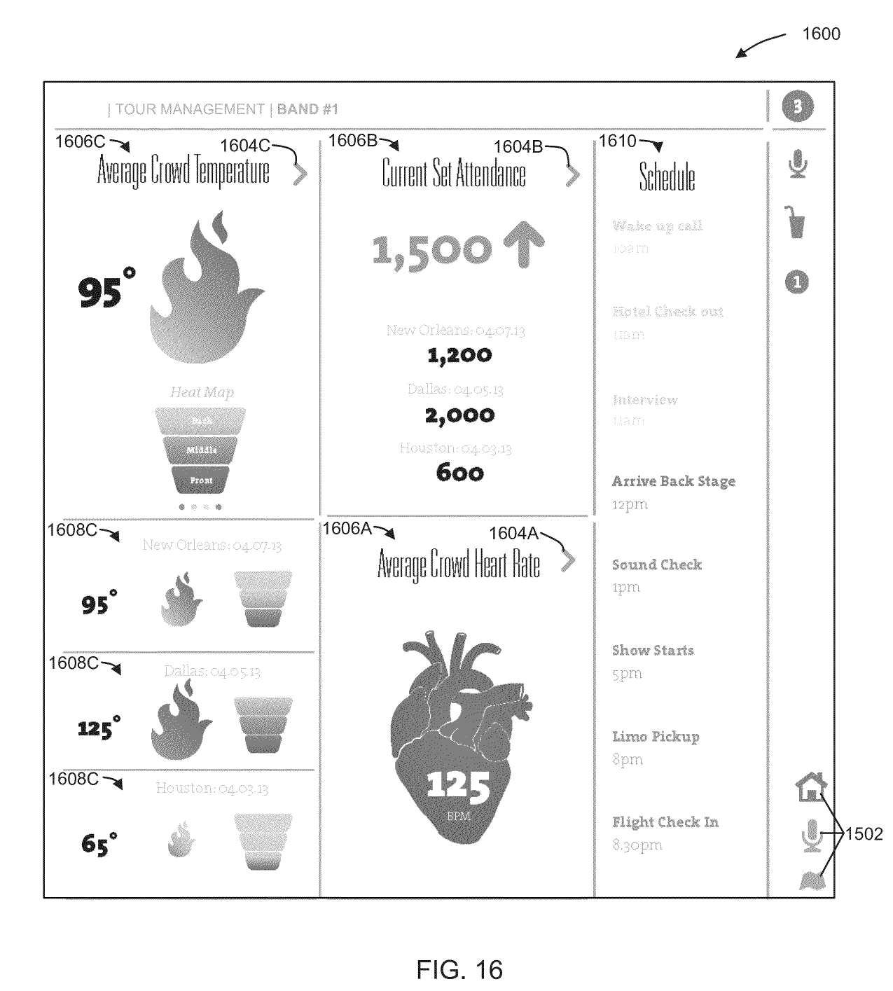

In some embodiments, the event manager 902 configures the user interface 906 for submitting, organizing, and reporting information related to the event management system. The event manager may employ a plurality of representations that are tailored to each type of information consumer. For example, in one embodiment the event management system is employed in the field of musical entertainment and the information consumers include, but are not limited to, artists, tour managers, and event producers. In this embodiment, the user interface is configured to present various representations tailoring the information presented based upon the type of information consumer. FIGS. 11 and 12A-D are diagrams illustrating an example user interface configured for an artist. FIGS. 13 and 14A-D are diagrams illustrating an example user interface configured for an event producer. FIGS. 15, 16, and 17A-C are diagrams illustrating an example user interface configured for a tour manager.

FIG. 11 illustrates an example artist dashboard view 1100 presented to an artist via the user interface. The artist dashboard view 1100 comprises a crowd heart rate frame 1102A, a crowd energy frame 1102B, a crowd temperature frame 1102C, and a set attendance frame 1102D, and transition buttons 1104A-D.

The user interface is configured to display an indication of the average crowd heart rate in the crowd heart rate frame 1102A of artist dashboard view 1100. The indication of the average crowd heart rate may comprise, for example, a heart graphic including the average crowd heart rate in beats per minute (BPM). In addition, the crowd heart rate frame may also comprise a transition button 1104A that causes a transition between the artist dashboard view 1100 and a crowd heart rate view 1200A illustrated in FIG. 12A. The crowd heart rate view 1200A includes a navigation panel 1202, a current crowd heart rate frame 1204A including a set button 1208A, and previous crowd heart rate frames 1206A.

The user interface is configured to display an indication of the average crowd heart rate over time in the current crowd heart rate frame 1206A of the crowd heart rate view 1200A. The indication of the average crowd heart rate over time may include a graphical representation (e.g., a line graph) of the determined instantaneous average heart rate throughout the event. The set button 1208A may cause the user interface to overlay an interactive grid on the graphical representation of the determined instantaneous average heart rate throughout the event. An example overlaid interactive grid is illustrated in the a current crowd energy frame 1204B of FIG. 12B. The previous crowd heart rate frames 1206A illustrated in FIG. 12A display a graphical representation of the average heart rate for previous performances. The navigation panel 1202 includes a plurality of buttons that transition between a plurality of views (e.g., artist dashboard view 1100, crowd heart rate view 1200A, crowd energy view 1200B, crowd temperature view 1200C, and set attendance view 1200D).

Referring back to the crowd energy frame 1102B of artist dashboard view 1100, the user interface is configured to display, within the crowd energy frame 1102B, an indication of the average crowd energy level. The indication of the average crowd energy level may comprise, for example, a gauge graphic illustrating a average crowd energy level. In addition, the crowd energy frame may also comprise a transition button 1104B that causes a transition between the artist dashboard view 1100 and a crowd energy view 1200B illustrated in FIG. 12B. The crowd energy view 1200B includes a navigation panel 1202, a current crowd energy frame 1204B including a set button 1208B, and previous crowd energy frames 1206B.

The user interface is configured to display an indication of the average crowd energy over time in the current crowd energy frame 1206B of the crowd energy view 1200B. This indication of the average crowd energy over time may include a graphical representation of the determined instantaneous average crowd energy throughout the event. The set button 1208B may cause the user interface to overlay an interactive grid on the graphical representation of the determined instantaneous average crowd energy throughout the event. For example, the interactive grid may allow a user to set a crowd energy level or confirm a crowd energy level determined by the event management system. The previous crowd energy frames 1206B illustrated in FIG. 12B display a graphical representation of the average crowd energy for previous performances. The navigation panel 1202 includes a plurality of buttons that transition between a plurality of views (e.g., artist dashboard view 1100, crowd heart rate view 1200A, crowd energy view 1200B, crowd temperature view 1200C, and set attendance view 1200D).

Referring back to the crowd temperature frame 1102C of artist dashboard view 1100, the user interface is configured to display, within the crowd temperature frame 1102C, an indication of the average crowd temperature. The indication of the average crowd temperature may comprise, for example, a flame graphic with an average crowd temperature in degrees Fahrenheit or degrees Celsius. In addition, the crowd temperature frame may also comprise a transition button 1104C that causes a transition between the artist dashboard view 1100 and a crowd temperature view 1200C illustrated in FIG. 12C. The crowd temperature view 1200C includes a navigation panel 1202, a current crowd temperature frame 1204C including a set button 1208C, and previous crowd temperature frames 1206C.

The user interface is configured to display an indication of the average crowd temperature over time in the current crowd temperature frame 1206C of the crowd temperature view 1200C. This indication of the average crowd temperature over time may include a graphical representation of the determined instantaneous average temperature throughout the event. The set button 1208C may cause the user interface to overlay an interactive grid on the graphical representation of the determined instantaneous average temperature throughout the event. An example overlaid interactive grid is illustrated in the a current crowd energy frame 1204B of FIG. 12B. The previous crowd temperature frames 1206C illustrated in FIG. 12C display a graphical representation of the average temperature for previous performances. The navigation panel 1202 includes a plurality of buttons that transition between a plurality of views (e.g., artist dashboard view 1100, crowd heart rate view 1200A, crowd energy view 1200B, crowd temperature view 1200C, and set attendance view 1200D).

Referring back to the set attendance frame 1102D of artist dashboard view 1100, the user interface is configured to display, within the set attendance frame 1102D, an indication of the current set attendance. The indication of the average set attendance may comprise, for example, a gauge graphic with a current set attendance number. In addition, the current set attendance frame may also comprise a transition button 1104D that causes a transition between the artist dashboard view 1100 and a set attendance view 1200D illustrated in FIG. 12. The set attendance view 1200D includes a navigation panel 1202, a current set attendance frame 1204D, and previous set attendance frames 1206D.

The user interface is configured to display an indication of the average current set attendance over time in the current set attendance frame 1206D of the current set attendance view 1200D. This indication of the average current set attendance over time may include a graphical representation of the determined current set attendance throughout the event. The set button 1208D may cause the user interface to overlay an interactive grid on the graphical representation of the determined current set attendance throughout the event. An example overlaid interactive grid is illustrated in the a current crowd energy frame 1204B of FIG. 12B. The previous current set attendance frames 1206D illustrated in FIG. 12D display a graphical representation of the set attendance for previous performances. The navigation panel 1202 includes a plurality of buttons that transition between a plurality of views (e.g., artist dashboard view 1100, crowd heart rate view 1200A, crowd energy view 1200B, crowd temperature view 1200C, and set attendance view 1200D).

FIG. 13 illustrates an example event producer dashboard view 1300 presented to an event producer via the user interface. The event producer dashboard view 1300 comprises a event attendance frame 1306A, a first stage attendance frame 1306B, a merchandise frame 1306C, an event map frame 1306D, a second stage attendance frame 1306E, an attendee entrance frame 1306F, a set list frame 1306G, a video feed frame 1306H, a social media frame 1306I, and transition buttons 1304A-D.

The user interface is configured to display an indication of the current event attendance in the event attendance frame 1306A of producer dashboard view 1300. The indication of the current set attendance may comprise, for example, a gauge graphic including the current number of event attendees. In addition, the event attendance frame 1306A may also comprise a transition button 1304A that causes a transition between the producer dashboard view 1300 and an event attendance view 1400A illustrated in FIG. 14A. The event attendance view 1400A includes a navigation button 1402, a current event attendance frame 1404A, a total attendance frame 1406A, an attendee entry frame 1408A, and a staff-attendee ratio frame 1410A.

The user interface is configured to display an indication of the current event attendance in the current event attendance frame 1404A of the event attendance view 1400A. The indication of the current set attendance may comprise, for example, a gauge graphic including the current number of event attendees. The user interface is also configured to display an indication of the total attendance over time. This indication of the total attendance over time may include a graphical representation of the determined total attendance throughout the event. The user interface is configured to display an indication of the ratio of door staff to incoming attendees in the staff-attendee ratio frame 1410A. This indication of the ratio of door staff to incoming attendees may include, for example, two bars of varying lengths that illustrate a relative number of attendees to door staff in addition to the ratio of door staff to incoming attendees.

The user interface may be further configured to display a graphical representation of the total attendance over time in the total attendance frame 1406A. The graphical representation of the total attendance over time may include, for example, a line graph outlining the attendance at various times throughout the event. The user interface may be further configured to display an indication of the attendee entry over time in the attendee entry frame 1408A. This indication of the attendee entry over time may include, for example, a bar chart indicating a number of attendee entrants during specific intervals of time during the event. In addition, the navigation button 1402 may cause a transition between the current view (e.g., event attendance view 1400A) and the producer dashboard view 1300.

Referring back to the first stage attendance frame 1306B of producer dashboard view 1300, the user interface is configured to display, within the first stage attendance frame 1306B, an indication of stage attendance over time. The indication of the stage attendance may comprise, for example, a line graph outlining the stage attendance at various times throughout the event. In addition, the event attendance frame 1306A may also comprise a transition button 1304A that causes a transition between the producer dashboard view 1300 and an first stage view 1400B illustrated in FIG. 14B. The event attendance view 1400B includes a navigation button 1402, an average stage attendance frame 1404B, a stage set list frame 1406B, a video feed frame 1408B, a stage attendance frame 1410B, and a stage annotations frame 1412B.

The user interface is configured to display an indication of the average stage attendance in the average stage attendance frame 1404B. The indication of the average stage attendance may include a gauge graphic with an average stage attendance number. The user interface may be further configured to display a list of stage set times in the stage set list frame 1406B and a live video stream from the current stage (e.g., the first stage) in the video feed frame 1408B. The stage attendance frame 1410B may include a line graph illustrating the stage attendance throughout the event. In addition, the line graph may include numbered annotations relating to the stage annotations display in the stage annotations frame 1412B.

Referring back to the merchandise frame 1306C of producer dashboard view 1300, the user interface is configured to display, within the merchandise frame 1306C, an indication of merchandise sold at the event. The indication of merchandise sold may include, for example, a graphic of a drink and a t-shirt. In addition, the merchandise frame 1306C may also comprise a transition button 1304C that causes a transition between the producer dashboard view 1300 and a merchandise view 1400C illustrated in FIG. 14C. The merchandise view 1400C includes a navigation button 1402, vendor frames 1404C, and a merchandise filter panel 1406C that includes a vendor stage area frame 1408C, a vendor zone frame 1410C, and a vendor category frame 1412C.

The user interface is configured to display an indication of the completed transactions between a vendor and various wearable device users in the vendor frame 1404C. The indication of the completed transactions may include, for example, a number of units sold, a rate of unit sales, and a number of units remaining in inventory. The indication of the average stage attendance may include a gauge graphic with an average stage attendance number. It is appreciated that the merchandise view 1400C may include any number of vendor frames 1404C.

The user interface may be further configured to display selected vendors that match one or more search criteria set by an information consumer via interaction with a merchandise filter 1406C. The specific search criteria to filter the displayed vendors may be displayed to the user through one or more frames embedded within the merchandise filter 1406C. The vendor stage area frame 1408C illustrates an example filter that includes a plurality of selectable numbered buttons that are indicative of vendors within specific stage area locations. The vendor zone frame 1410C illustrates another example filter that includes a plurality of selectable buttons that are indicative of vendors within specific vendor zones. The vendor category frame 1412C illustrates another example filter that includes a plurality of labeled icons indicative of various selectable categories of vendors (e.g., food vendors, alcohol vendors etc.).

Referring back to the event map frame 1306D of producer dashboard view 1300, the user interface is configured to display, within the event map frame 1306D, an indication of an event map. The indication of the event map may include, for example, a graphic of a map (e.g., a treasure map). In addition, the event map frame 1306D may also comprise a transition button 1304D that causes a transition between the producer dashboard view 1300 and an event map view 1400D illustrated in FIG. 14D. The event map view 1400D includes a navigation button 1402, an event map filter panel 1404D, an event map frame 1406D, and event map filter buttons 1408D.

The user interface may be configured to display a configurable event map in the event map frame 1406D. The event map, for example, may selectively display locations of interest (e.g., event exits, event entrances, food stand locations, stage locations, restroom locations, etc) in addition to event attendee locations. The locations of interest and event attendee locations are selected via event map filter buttons 1408D. In addition, the number of event map frames 1406D displayed may be selectable. For example, the event map filter panel 1404D may contain a list of various times. Upon selection of any time from the list in the event map filter panel 1404D, the user interface may add another event map frame 1406D indicative of the event area at the selected time.

Referring back to the second stage attendance frame 1306E of producer dashboard view 1300, the user interface is configured to display, within the second stage attendance frame 1306E, an indication of stage attendance over time regarding a second stage. The indication of the stage attendance may comprise, for example, a line graph outlining the stage attendance at various times throughout the event. In addition, the event attendance frame 1306E may also comprise a transition button 1304E that causes a transition between the producer dashboard view 1300 and a second stage view. It is appreciated that in various embodiments, the second stage view comprises a similar view to the first stage view 1400B described above with reference to FIG. 14B that includes information pertinent to the second stage.

The user interface may be further configured to display an indication of attendance entry over time in the attendee entrance frame 1306F. The indication of attendance entry over time may include a line graph illustrating the specific number of individuals entering the event at various times throughout the event. It is appreciated that this number may be cumulative. The user interface may be further configured to display various set times for one or more stages in the set list frame 1306G. The set list time frame 1306G may include a plurality of selectable buttons that allow the displayed set times within the set list times frame 1306G to be changed between any one of a plurality of stages. In addition, the event producer dashboard view 1300 may comprise a video feed frame 1306H that displays live video from one or more stages at the event. A social media frame 1306I may also be included to display relevant notifications from various social media sites.

FIG. 15 illustrates an example tour manager dashboard view 1500 presented to a tour manager via the user interface. The tour manager view 1500 comprises navigation buttons 1502, a concierge frame 1504, a forecast frame 1506, a lodging frame 1508, a transportation frame 1510, a task list frame 1512, a contacts frame 1514, and a schedule frame 1516.

The tour manager dashboard view displays the schedule of the various bands in the schedule frame 1516. Additional schedule information such as transportation arrangements and lodging arrangements may be displayed in the transportation frame and the lodging frame respectively. Local events such as available food services and the local weather may be displayed in the concierge frame 1504 and forecast frame 1506 respectively. A configurable task list is also presented to the tour manager in the task list frame 1512 in addition to key contacts in the contacts frame 1514.

The tour manager dashboard view 1500 displays information relevant to one or more bands the tour manager is overseeing. In some embodiments, one or more of the navigation buttons open a navigation panel where various combinations of bands may be selected for more detailed analysis. In these embodiments, only information from the selected bands is displayed in the various frames in the tour manager dashboard view. In addition, the navigation buttons may cause a transition from the tour manager dashboard view to a band dashboard view 1600 that displays detailed information relevant to the selected band or combination of bands.

The band dashboard view 1600 displays more detailed information pertaining to a single band relative to the tour manager dashboard view. The band dashboard view 1600 includes navigation buttons 1502, a crowd heart rate frame 1606A, a set attendance frame 1606B, a crowd temperature frame 1606C, previous crowd temperature frames 1608C, a schedule frame 1610, and transition buttons 1604A-C.

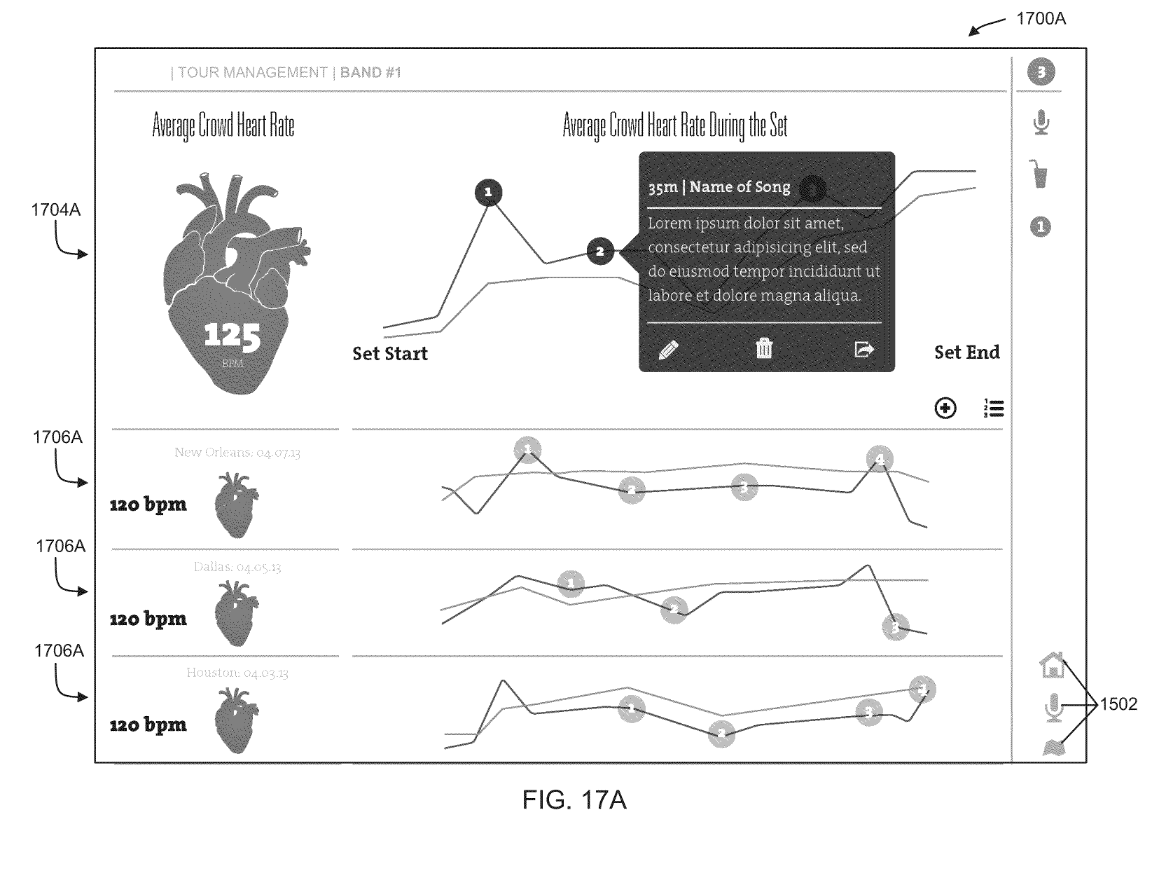

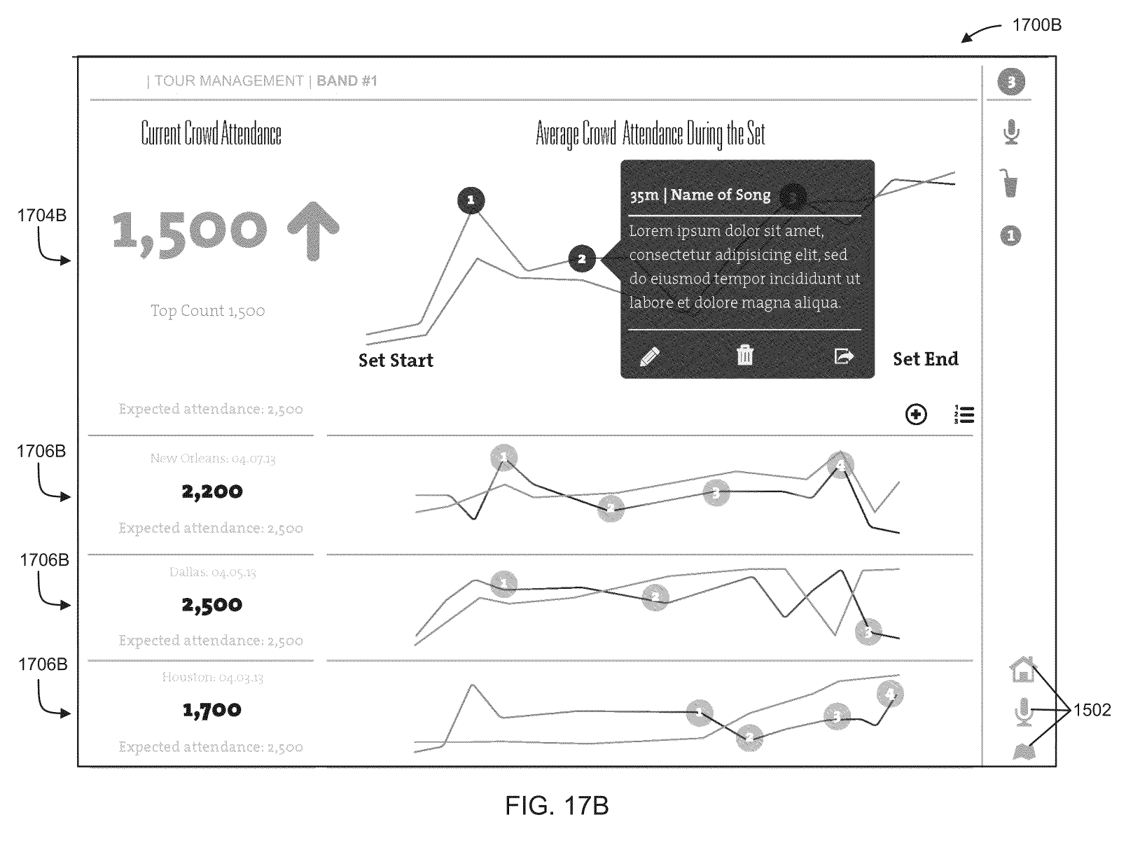

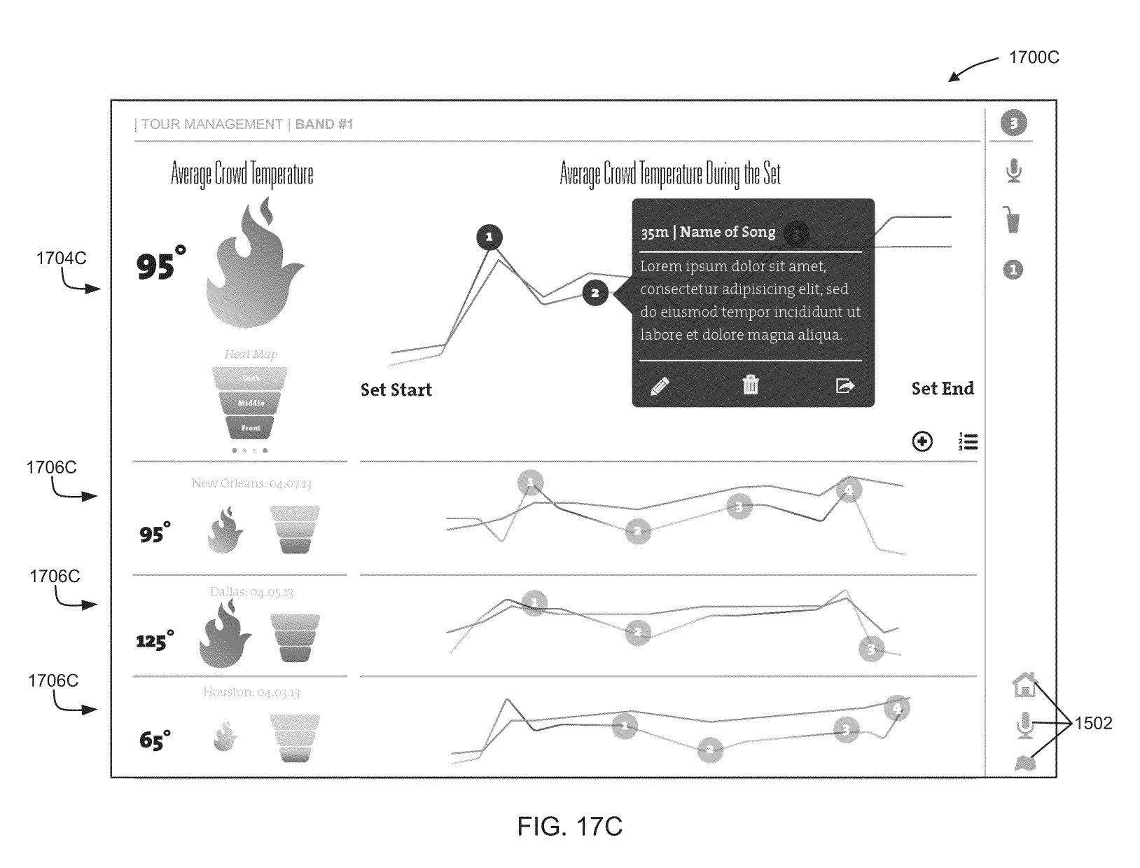

In the crowd heart rate frame 1606A of band dashboard view 1600, the user interface is configured to display an indication of the average crowd heart rate. The indication of the average crowd heart rate may comprise, for example, a heart graphic including the average crowd heart rate in beats per minute (BPM). In addition, the crowd heart rate frame may also comprise a transition button 1604A that causes a transition between the band dashboard view 1600 and a crowd heart rate view 1700A illustrated in FIG. 17A. The crowd heart rate view 1700A includes navigation buttons 1502, a current crowd heart rate frame 1704A, and previous crowd heart rate frames 1706A.

In the current crowd heart rate frame 1704A of the crowd heart rate view 1700A, the user interface is configured to display an indication of the average crowd heart rate over time in addition to the current average crowd heart rate. This indication may include a graphical representation of the determined instantaneous average heart rate throughout the event in addition to a heart graphic including the average crowd heart rate in beats per minute (BPM). The previous crowd heart rate frames 1706A illustrated in FIG. 17A display a graphical representation of the average heart rate over time for previous performances.

Referring back to the set attendance frame 1606B of band dashboard view 1600, the user interface is configured to display, within the set attendance frame 1606B, an indication of the current set attendance. The indication of the current set attendance may comprise, for example, a current set attendance number. In addition, the current set attendance frame may also comprise a transition button 1604B that causes a transition between the band dashboard view 1600 and a set attendance view 1700B illustrated in FIG. 17B. The set attendance view 1700B includes navigation buttons 1502, a current set attendance frame 1704B, and previous set attendance frames 1706B.

In the current set attendance frame 1706B of the set attendance view 1700B, the user interface is configured to display an indication of the current set attendance over time. This indication of the average current set attendance over time may include a graphical representation of the determined current set attendance throughout the event and a current set attendance number. The previous current set attendance frames 1706B illustrated in FIG. 17B display a graphical representation of the set attendance for previous performances.

Referring back to the crowd temperature frame 1606C of band dashboard view 1600, the user interface is configured to display, within the crowd temperature frame 1606C, an indication of the average crowd temperature. The indication of the average crowd temperature may comprise, for example, a flame graphic with an average crowd temperature in degrees Fahrenheit or degrees Celsius in addition to a heat map illustrating a distribution of heat within the crowd. In addition, the crowd temperature frame may also comprise a transition button 1604C that causes a transition between the band dashboard view 1600 and a crowd temperature view 1700C illustrated in FIG. 17C. The crowd temperature view 1700C includes navigation buttons 1502, a current crowd temperature frame 1704C, and previous crowd temperature frames 1706C.

In the current crowd temperature frame 1706C of the crowd temperature view 1700C, the user interface is configured to display an indication of the average crowd temperature over time. This indication of the average crowd temperature over time may include a graphical representation of the determined instantaneous average temperature throughout the event. The set button 1708C may allow a user to set an estimated average temperature of the crowd. The previous crowd temperature frames 1706C illustrated in FIG. 17C display a graphical representation of the average temperature for previous performances.

Referring back to the previous crowd temperature frames 1608C of band dashboard view 1600, the user interface is configured to display, within the crowd temperature frames 1608C, an indication of the average crowd temperature at previous events. The indication of the average crowd temperature at previous events may comprise, for example, a flame graphic with an average crowd temperature in degrees Fahrenheit or degrees Celsius in addition to a heat map illustrating a distribution of heat within the crowd.

The information displayed to the various information consumers via the user interface described above is computed through the execution of one or more event manager processes that may store the computed parameters in a location accessible by the user interface. For example, the event manager determine an approximate location for each wearable device user presented in the event map frame 1406D in the event producer view 1400D.

### Event Manager Processes

Various embodiments implement and enable processes through which an event manager aggregates, analyzes, and outputs information from a plurality of wearable devices. In these embodiments, the event manager executes a connection process to establish a connection with one or more wearable devices. FIG. 18 illustrates on such connection process 1800 that includes the acts of finding the closest reader to the wearable device 1802, connecting to the wearable device 1804, requesting a security token from the wearable device 1806, decoding the received security token 1808, transmitting the decoded security token 1810, determining whether the wearable device maintained the connection 1812, and beginning communication with the wearable device 1814.

In act 1802, the event manager finds the closest reader to the wearable device. In one embodiment, the closest reader to the wearable device is found by analyzing the received signal strength of the wearable device at a plurality of readers. The reader with the strongest received signal strength may be selected from the set of readers within communication range with the device.

In act 1804, the event manager connects to the wearable device. The event manager subsequently requests a security token from the wearable device in act 1806. In response to receiving the requested security token, the event manager decodes the security token in act 1808. The decoded security token may then be transmitted back to the wearable device in act 1810. The event manger determines whether the wearable device remained connected to the event manager in act 1812. Determining whether the wearable device remained connected may include waiting a predetermined amount of time (e.g., 1 second) and attempting to communication with the wearable device. If the wearable device is still connected in act 1812, the event manager continues to act 1814 and begins communication with the wearable device. Otherwise, the event manager continues back to act 1802 of finding the closest reader to the wearable device and completes a second iteration of the connection process 1800. It is appreciated that the event manager may select a different reader in the second iteration than in the first iteration.

As discussed above with regard to the user location tracking component 908 in FIG. 9, various embodiments of the user location tracking component 908 cause the event manager to perform one or more location verification processes. FIG. 19 illustrates one such location verification process 1900 that includes acts of detecting a user entering a new zone 1902, requesting a UUID from the wearable device 1904, and receiving a UUID from the wearable device 1906, determining whether the user has access to the zone 1908, transmitting access granted status to the wearable device 1910, transmitting access denied status to the wearable device 1912, and flagging a UUID 1914.

In act 1902, the event manager detects a user entering a new zone. The new zone may, for example, be an entrance to a concert reserved for ticket holders or access to a restricted area of the concert reserved for back-stage pass holders. The event manager subsequently requests a UUID from the wearable device in act 1904. The event manager receives the UUID in act 1906 and proceeds to determine whether the user should be granted access in 1908. The act 1908 of determining access may include comparing the received UUID to a database including a table associating UUIDs with levels of access. If the user is granted access in act 1908, the event manager transmits an access granted status to the wearable device in act 1910. Otherwise, the event manager transmits an access denied status to the wearable device in act 1912. The UUID may subsequently be flagged in act 1914 for possible fraud.

As discussed above with regard to the user transaction component 910 in FIG. 9, various embodiments of the user transaction component 910 cause the event manager to perform one or more transaction verification processes. FIG. 20 illustrates one such transaction verification process 2000 that includes acts of receiving transaction verification request 2002, transmitting a user biometric 2004, receiving biometric verification or denial 2006, determining whether the user biometric was verified 2008, transmitting verification request to wearable device 2010, receiving verification or denial from wearable device 2012, determining whether the transaction was verified by user 2014, and logging the transaction 2016.

In act 2002, the event manager receives a transaction verification request from an external entity. The external entity may include, for example, a merchant engaging in a financial transaction with a wearable device user. The event manager transmits biometric information of the user to the external entity in act 2004. This biometric information may include, for example, a picture of the user. The event manager may then receive a user biometric verification or denial from the external entity in act 2006.

The event manager determines whether the user biometric was verified or denied in act 2008. If the user biometric was verified by the external entity, the event manage system transmits a verification request to the wearable device in act 2010. Otherwise, the wearable device proceeds to act 2016 and logs the transaction for a possible fraud attempt. Referring back to act 2010 of transmitting the verification request, the event manager receives a response from the wearable device in act 2012. The event manager may then determine whether the wearable device verified the transaction in act 2014. If the transaction is verified by the user, the event manager completes process 2000 and completes the transaction. Otherwise, the transaction is logged in act 2016 as a possible fraud attempt.

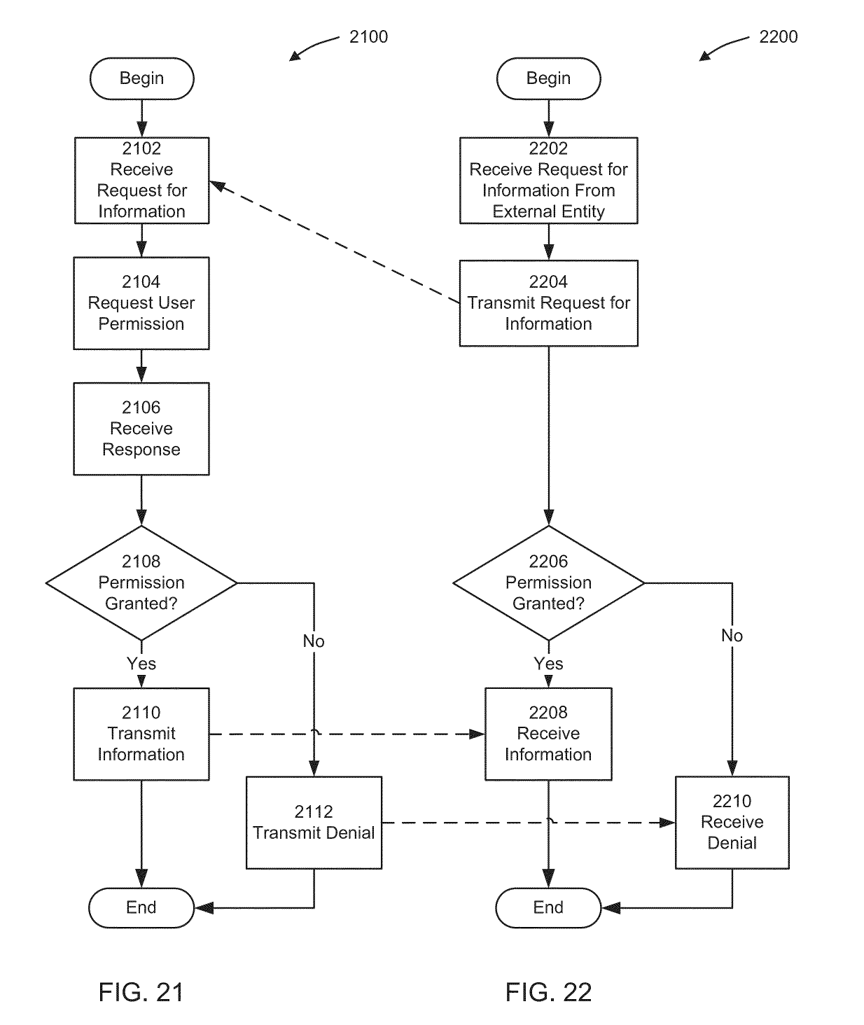

It is appreciated that various embodiments of the event manager support one or more information request processes in addition to the transaction processes described above. FIG. 21 illustrates an example information request process performed by a wearable device (e.g., wearable device 104) that includes acts of receiving a request for information 2102, requesting user permission 2104, receiving a response 2108, determining whether permission was granted 2108, transmitting information 2110 and transmitting a denial 2112. FIG. 22 illustrates a complement example information request process performed by the event manager (e.g., event manager 902) that includes the acts of receiving a request for information from an external entity 2202, transmitting a request for information 2204, determining whether information was received 2206, receiving information 2208, and receiving a denial 2210.

In act 2202, the event manager receives an information request from an external entity. The external entity may include, for example, a request from an external entity for biometric or demographic information (e.g., name, address, etc.) associated with a user in exchange for allowing the user to participate in a contest or enter a restricted area. The event manager transmits a request for user information in act 2204.

In act 2102, the wearable device receives a request for information from the event manager. The wearable device requests user permission in act 2104. Requesting user permission may include requesting the user to perform a specified action (e.g., performing a finger snap, performing a preconfigured gesture, or performing other movement). In act 2106, the wearable device receives the a response from the user. The wearable device determines in act 2108 whether the user granted permission (e.g., by completing the specified action). If the wearable device detects that specified action was completed, the wearable device transmits the information to the event manager in act 2110. Otherwise, the wearable device transmits a denial message to the event manager in act 2112. The event manager receives the transmission from the wearable device, decodes the transmission, and parses the information included in the transmission to determine whether permission was granted in act 2206. If permission was granted in act 2206, the event manager records the information in act 2208. Otherwise, the event manager records a denial in act 2210.

Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements.

Having now described some illustrative aspects of the invention, it should be apparent to those skilled in the art that the foregoing is merely illustrative and not limiting, having been presented by way of example only. Similarly, aspects of the present invention may be used in at a variety of venues (e.g., movie theatres, amusement parks, casinos, cruise ships, restaurants, hotels, etc) to collect and analyze information from the wearable device users (e.g., customers). For example, according to one embodiment, a movie producer may monitor the responses (e.g., heart rate and energy level) of a plurality of wearable device users during a horror movie screening to analyze a scare factor of the movie. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives.

What is claimed is:

1. An event management system comprising:
at least one wearable device including:
a wearable support structure;
a display coupled to the wearable support structure;
a plurality of sensors coupled to the wearable support structure;
a controller removably coupled to the display, the plurality of sensors, and the wearable support structure, the controller including one or more processors coupled to a memory and one or more antennas;
a user manager component executable by the one or more processors of the controller and configured to create anonymous biometric information descriptive of at least one user wearing the at least one wearable device based at least in part on information received from the plurality of sensors and transmit at least one portion of the anonymous biometric information.

2. The event management system according to claim 1, wherein the wearable support structure includes at least one of a wristband, a pair of glasses, a belt buckle, a headband, and a ring.

3. The event management system according to claim 1, wherein the plurality of sensors includes at least one of an accelerometer, a microphone, a temperature sensor, a galvanic skin response sensor, and a heart rate sensor.

4. The event management system according to claim 1, wherein the user manager is configured to verify transactions between the at least one user and a third party.

5. The event management system according to claim 4, wherein the user manager is configured to verify the transactions between the at least one user and the third party at least in part by:
receiving a user verification request;
requesting the at least one user to perform an action;
determining whether the action was performed based at least in part on the information received from the plurality of sensors; and
transmitting a user verification outcome.

6. The event management system according to claim 5, wherein the user manager is configured to request an action that moves the at least one wearable device according a predetermined movement.

7. The event management system according to claim 1, wherein the at least one wearable device includes a plurality of wearable devices, the at least one user includes a plurality of users, and the user manager component is configured to transmit anonymous biometric information to an external system comprising:
a memory;
one or more processors communicatively coupled with the memory and the plurality of wearable devices;
an event manager executable by the one or more processors and configured to:
aggregate anonymous biometric information received from each wearable device of the plurality of wearable devices into aggregated biometric information descriptive of the plurality of users; and
provide a selected portion of the aggregated biometric information to one or more information consumers.

8. The event management system according to claim 7, wherein the memory further stores associations between the one or more information consumers and one or more information consumer types, the information consumer types including at least an artist type, an event manager type, and a tour management type and the event manager is configured to provide the selected portion of the aggregated biometric information based upon the associations.

9. The event management system according to claim 7, wherein the event manager is further configured to facilitate a transaction between a user of the plurality of users and the third party.

10. The event management system according to claim 9, wherein the memory stores biometric information descriptive of each user of the plurality of users and the event manager is configured to facilitate the transaction at least in part by:
receiving a transaction request from the third party identifying the user;
transmitting, in response to receiving the transaction request, biometric information of the user to an information consumer;
receiving a confirmation of matching biometric information from the information consumer;
transmitting, in response to receiving the confirmation, a user verification request to a wearable device worn by the user; and
receiving a user verification from the wearable device.

11. An event management system according to claim 7, wherein the memory stores the aggregated biometric information, the aggregated biometric information including at least one of an aggregate heart rate, an aggregate temperature, and an aggregate energy level for the plurality of users.

12. An event management system according to claim 11, wherein the event management system further comprises an interface component executable by the one or more processors and configured to:
retrieve at least one portion of the aggregated biometric information from the memory; and
present a first representation based on the aggregated biometric information, the first representation including an indication of at least one of a current event attendance, an average crowd heart rate, an average crowd temperature, and an average crowd energy level.

13. The event management system according to claim 12, wherein the interface component is further configured to:
present a second representation including an indication of at least one of a current set attendance, an event map, and merchandise sold; and
present a third representation including an indication of at least one of an artist transportation schedule, an artist lodging schedule, and an artist performance schedule.

14. An event management system for providing information regarding a plurality of users to one or more information consumers, the event management system comprising:
a memory storing aggregated biometric information regarding a plurality of users, the aggregated biometric information including at least one of a heart rate, a temperature, and an energy level for the plurality of users;
one or more processors coupled to the memory; and
an interface component executable by the one or more processors and configured to:
retrieve at least one portion of the aggregated biometric information from the memory; and
present a first representation based on the aggregated biometric information, the first representation including an indication of at least one of a current event attendance, an average crowd heart rate, an average crowd temperature, and an average crowd energy level.

15. The event management system according to claim 14, wherein the interface component is further configured to:
present a second representation including an indication of at least one of a current set attendance, an event map, and an indication of merchandise sold; and
present a third representation including an indication of at least one of an artist transportation schedule, an artist lodging schedule, and an artist performance schedule.

16. The event management system according to claim 15, wherein the memory further stores associations between the one or more information consumers and one or more information consumer types, the information consumer types including at least an artist type, an event manager type, and a tour management type and the interface is configured to retrieve the at least one portion of the aggregated biometric information based upon the associations.

17. A method of managing an event, the method comprising:
receiving, by at least one wearable device, biometric information descriptive of at least one user; and
transmitting, by the at least one wearable device, anonymous biometric information using the biometric information.

18. The method according to claim 17, further comprising:
receiving the anonymous biometric information; and
aggregating the anonymous biometric information into aggregated biometric information.

19. The method according to claim 18, further comprising providing the aggregated biometric information to an information consumer.

20. The method according to claim 19, wherein providing the aggregated biometric information includes providing the aggregated biometric information to an artist performing at the event.
